(19) United States
(12) Patent Application Publication
(10) Pub. No.: US 2016/0117440 A1
(43) Pub. Date: Apr. 28, 2016

(54) SYSTEM AND METHOD FOR AUTOMATED PREDICTION OF VULNERABILITIES IN BIOLOGICAL SAMPLES

(71) Applicant: MEMORIAL SLOAN-KETTERING CANCER CENTER, New York, NY (US)

(72) Inventors: Bulent Arman AKSOY, New York, NY (US); Chris SANDER, New York, NY (US)

(21) Appl. No.: 14/894,138

(22) PCT Filed: May 29, 2014
(86) PCT No.: PCT/US2014/040027

§ 371 Date: Nov. 25, 2015

Related U.S. Application Data
(60) Provisional application No. 61/828,816, filed on May 30, 2013.

(51) Int. Cl. G06F 19/18; G06F 19/00

(52) U.S. Cl. CPC G06F 19/18; G06F 19/3487

(57) ABSTRACT

In order to exploit vulnerabilities of cancer cells on the basis of homozygous deletion, a genomic profile of cancer cells in a biological sample is analyzed to identify homozygous deletions of one or more genes. The homozygous deletions, in turn, are analyzed in view of pathway data (e.g., metabolic, signaling, and/or cell-to-cell communication pathway data obtained from one or more databases) to determine a subset of homozygous deletions performing a function important to the viability of the cell. From this subset of homozygous deletions, cellular pathway data is analyzed to identify one or more partner genes (e.g., synthetic lethals) considered to facilitate or perform the same or similar function as the respective homozygous deletion. Drug annotations, in turn, may be reviewed to identify drugs that inhibit at least one of the synthetic lethal genes and/or gene products.

### RELATED APPLICATIONS

The present application claims priority to and the benefit of U.S. Provisional Patent Application Ser. No. 61/828,816, filed May 30, 2013, titled “System and Method for Automated Prediction of Vulnerabilities in Biological Samples,” the content of which is incorporated herein by reference in its entirety.

### BACKGROUND

A primary goal of cancer treatment is to inhibit the proliferation of cancer cells and/or cause their death. Many cancer treatments designed to inhibit or kill cancer cells have undesirable side effects due to harmful activity in noncancer cells. An ideal cancer therapy is one that selectively affects cancer cells while causing minimal harm to noncancer cells.

Array-based competitive genomic hybridization methods have provided the opportunity for large-scale analysis of the cancer genome to aid the hunt for therapeutic targets. Comprehensive cancer studies, like The Cancer Genome Atlas (TCGA), have shown a vast number of genomic alterations in cancer genomes. These genomic alterations may result from either genomic instability of a cancer cell or the advantage imposed on the cancer cell due to loss of a tumor-suppressor gene because of a homozygous deletion.

Genomic alterations that may be advantageous to the proliferative capacity of a cancer cell, such as the homozygous deletion of a tumor-suppressor gene, may create one or more collateral vulnerabilities as a result of the concomitant deletion of other genes that encode functional products essential for cell survival. A mutation or deletion of a gene responsible for a core cellular function may not be lethal to a cell if one or more unaffected partner genes (e.g., a homologue) can sufficiently carry the load. However, upon loss of an initial gene, interference with the activity or function of its partner gene(s) may result in cell death, a phenomenon known as synthetic lethality.

The concept of synthetic lethality may be illustrated, for example, by the multiple genes encoding the enzyme enolase. Enolase performs an essential function in cells, catalyzing the interconversion of 2-phosphoglycerate and phosphoenolpyruvate in the glycolytic pathway. At least three known genes encode enolase isozymes, ENO1, ENO2, and ENO3. (Muller et al. (2012) Nature 488:337-343). ENO1 has been shown to be homozygously deleted in certain glioblastomas, but the tumor cells are able to survive due to the activity of other enolase encoding genes, in particular ENO2. Although the loss of ENO1 alone may not be lethal, cancer cells lacking ENO1 are selectively vulnerable to the loss of ENO2 (i.e., synthetic lethality), whereas noncancer cells with intact ENO1 can tolerate a loss of ENO2.

Thus, there is opportunity to exploit synthetic lethalities specific to particular populations of cancer cells created by the homozygous loss of genes responsible for core cellular functions. However, there are no existing tools for identifying these vulnerabilities and using this information to identify drugs and/or therapies to inhibit or kill cancer cells of a particular patient. A need exists for a system that can efficiently analyze genomic data from biological samples to identify particular therapeutic vulnerabilities in cancer cells specific to those samples based on potential synthetic lethal partner genes and identify drugs and/or therapies to inhibit or kill those cancer cells.

### SUMMARY

Genomic alterations that confer a proliferative advantage to cancer cells include, for example, loss of one or more tumor-suppressor genes due to homozygous deletions. Such homozygous deletions typically result in the loss of multiple genes in a given locus, which often includes gene encoding products (e.g., enzymes or other polypeptides) core to cell viability. When loss of an initial gene necessary for cell viability does not result in cell death, it is likely due to the existence of one or more partner genes (e.g., genes which perform the same function) within the cell. Subsequent inhibition of the partner gene, for example, by inhibition of gene expression (e.g., siRNA, shRNA, miRNA, and the like) or by inhibition of the gene product (e.g., a drug that inhibits an enzyme or polypeptide encoded by the gene) may then result in cell lethality due to the specific vulnerability created by loss of the initial gene. Thus, the homozygous deletions can result in therapeutic vulnerabilities when the deleted gene has partners that are synthetic lethal for the cell. As used herein, the term “synthetic lethal” or synthetic lethality” includes the killing of a cell, as well as a reduction or prevention of proliferation or other oncogenic process. By identifying one or more drugs known to inhibit each partner gene and/or gene product of a homozygously deleted gene, a targeted drug therapy can be supplied to a patient that, while proving lethal to the cancer cells, will not destroy healthy (e.g., noncancer) cells. The cancer cells are specifically vulnerable to drug therapies that selectively target partner genes of a homozygously deleted gene. In contrast, noncancer cells are able to tolerate such drug treatments. Noncancer cells do not have the same vulnerability because the initial gene (i.e., the gene homozygously deleted in cancer cells) remains intact in the noncancer cells to carry out core functions while its partner gene or gene product is inhibited by the drug.

Besides homozygous deletions, other types of genomic or epigenetic alterations can also lead to vulnerabilities in cancer cells. A gene bearing homozygous mutations for example, can be rendered disabled or non-functional due to disruptions caused by these mutations. For example, one or more copies of a gene may contain a mutation so as to code for an amino acid substitution and/or may contain a truncation, resulting in no gene copy being fully functional. Information regarding whether a particular mutation is likely to have an impact on the function of a gene product can be collected as annotation from external resources, for example, such as COSMIC (Forbes et al, 2011 Nucleic Acids Research 39(S1), p. D945-950) or Mutation Assessor (Reva et al., 2011 Nucleic Acids Research 39(17), p. e118), or other source providing sequencing information on a particular gene for the sample of interest.

Moreover, in situations where gene-centric DNA methylation data is available, information about hyper-methylated genes can be utilized to infer vulnerabilities. Similar to that of Copy Number Alteration or Copy Number Variation data, a threshold on the continuous methylation level for a particular gene can provide information whether the DNA coding for a gene is hyper-methylated compared to background levels. For many genes, there are multiple regions that are covered by these methylation assays, but typically it is the “upstream” of the gene that contains the regulatory region. If the gene is hyper-methylated, then the gene would be expected to be under-expressed or not expressed at all.

As with homozygous deletion or mutation events, hyper-methylation events are expected to cause an under-expression or lack of expression of the gene of interest and create vulnerability in the cell. If the gene that is the target of a hyper-methylation event is either under-expressed or not expressed, such information can be a factor contributing to the vulnerability score.

Similarly to homozygous deletions, cancer cells harboring mutated, hyper-methylated, or otherwise disabled genes are specifically vulnerable to drug therapies that selectively target partner genes of the disabled gene. In contrast, noncancer cells are able to tolerate such drug treatments. Noncancer cells do not have the same vulnerability because the initial gene (i.e., the gene disabled in cancer cells) remains intact in the noncancer cells to carry out core functions while its partner gene or gene product is inhibited by the drug.

In certain embodiments, in order to exploit vulnerabilities of cancer cells on the basis of homozygous deletion, a genomic profile of the cancer cells in a biological sample is analyzed to identify homozygous deletions of one or more genes. The homozygous deletions, in turn, are analyzed in view of pathway data (e.g., metabolic, signaling, and/or cell-to-cell pathway information obtained from one or more databases) to determine a subset of homozygous deletions in a core pathway (e.g., performing a function considered to be essential to the viability of the cell). From this subset of homozygous deletions, pathway data is analyzed to identify one or more partner genes (e.g., synthetic lethals) considered to perform the same function as the respective homozygous deletion. Drug annotations (e.g., obtained from one or more external resources), in turn, may be reviewed to identify drugs that selectively inhibit at least one of the partner genes and/or gene products. A drug that “selectively inhibits” at least one of the partner genes and/or gene products may have additional targets, but does not substantially inhibit the homozygously deleted gene and/or gene product). One or more of the identified drugs may then be used in validation tests (e.g., in vitro laboratory tests against one or more cell lines having the identified homozygous deletion) to confirm specific lethality to cancer cells.

Prior to validating identified drug therapies, in some implementations, the homozygous deletion—synthetic lethal combinations may be analyzed (e.g., scored and/or ranked) based upon a number of factors. For example, each gene expected to be homozygously deleted may be evaluated to confirm its lack of expression (or under-expression) in cells of the biological sample. Further, each homologous deleted-synthetic lethal combination may be analyzed based upon a number of drugs required (e.g., one drug targeted to one partner vs. two drugs, each targeted to one of two partners, etc.), whether each targeted drug has obtained approval for use in humans (e.g., drug regulatory agency approval, such as the United States Food and Drug Administration (FDA)), and a relative predicted lethality/toxicity of the proposed drug therapy (e.g., whether the function performed by the homozygous deletion is deemed a core function of the cell, whether the function performed by the homozygous deletion is deemed essential to the viability of one or more designated organisms, whether each targeted drug is believed to act at additional targets, etc.).

In some implementations, identification of drug therapies may be made using a set of genomic profiles (e.g., cancer study samples). In this circumstance, a particular homozygous deletion—synthetic lethal combination may be promoted based upon the homozygous deletion being present in one or more cell lines of the set of genomic profiles. By verifying functionality of the drug therapy within one or more cell lines, for example, a relative confidence of the drug therapy being specific for destruction of tumor cells having the particular homozygous deletion is increased.

In some implementations, identification of drug therapies may be made using a set of genomic profiles (e.g., cancer study samples). In this circumstance, a particular homozygous deletion—synthetic lethal combination may be promoted based upon the homozygous deletion being present in at least two cell lines of the set of genomic profiles. By verifying functionality of the drug therapy within two or more cell lines, for example, a relative confidence of the drug therapy being specific for destruction of tumor cells having the particular homozygous deletion is further increased. In some implementations, analysis results are presented in a graphical user interface for review by a laboratory technician or other medical professional. The analysis results, in some examples, include information regarding a sample (e.g., genomic profile including the particular homozygous deletion), a description of the function performed by the homozygous deletion, the name of the gene which is homozygously deleted, and/or a score indicating a relative likelihood of success of tumor suppression based upon targeted drug therapy of synthetic lethal(s) of the homozygous deletion. In some implementations, annotation data may be reviewed to obtain additional information regarding the homozygous deletion and/or targeted drug(s).

In one aspect, the present disclosure relates to a method including accessing genomic profile data of a biological sample, and identifying, by a processor of a computing device, within the genomic profile data, one or more homozygous deletions. The method may include identifying, by the processor, for each homozygous deletion of a subset of the one or more homozygous deletions, at least one respective vulnerability, where identifying the respective vulnerability includes identifying, for the respective homozygous deletion, one or more partner genes as synthetic lethal for a cell of the biological sample. The method may include identifying, by the processor, for each gene of a subset of the one or more partner genes of at least a first homozygous deletion of the subset of homozygous deletions, at least one respective drug known to inhibit the gene and/or a product of the gene. The method may include providing, by the processor, for review by a medical professional, information regarding the at least one vulnerability and the at least one respective drug.

In some embodiments, prior to accessing the genomic profile data, the method includes obtaining the biological sample, and analyzing the biological sample, where analyzing the biological sample includes performing at least one of a hybridization assay analysis and a gene sequencing analysis. Identifying the respective vulnerability may include identifying a number of vulnerabilities, each vulnerability of a number of vulnerabilities associated with a respective homozygous deletion of the subset of homozygous deletions. The method may include, prior to providing the information, analyzing the number of vulnerabilities in light of one or more factors to promote one or more vulnerabilities identified as being likely candidates for therapeutic success.

In some embodiments, analyzing the number of vulnerabilities includes scoring each vulnerability of the number of vulnerabilities based upon values associated with the one or more factors. The one or more factors may include one or more drug selection factors including at least one of a) a drug regulatory agency approval status, b) a drug regulatory agency approval for cancer indication, and c) a number of additional targets modulated by the drug. Identifying the respective drug may include identifying the one or more drug selection factors.

In some embodiments, the one or more factors include one or more vulnerability selection factors including at least one of a) an essential gene designation of the homozygous deletion, b) a tissue specific designation of at least one partner gene of the one or more partner genes, and c) a core pathway function designation of the homozygous deletion. Identifying the vulnerability may include identifying the one or more vulnerability selection factors. The profile data may include a tissue annotation designating a lineage of a tumor from which the biological sample was derived, and analyzing the number of vulnerabilities in light of the one or more factors may include analyzing whether the tissue specific designation of each respective partner gene identifies the respective partner gene as being expressed within a type of tissue designated by the tissue annotation.

In some embodiments, providing the information includes providing values related to the one or more factors. The one or more factors may include a gene expression level of the homozygous deletion within the biological sample. The respective gene expression level may include one of under-expressed and not expressed. Promoting one or more vulnerabilities may include scoring the number of vulnerabilities according to the one or more factors. Providing the information may include providing, for each vulnerability of the number of vulnerabilities, a visual scale indicator, where the visual scale indicator identifies relative anticipated therapeutic success.

In some embodiments, identifying the one or more homozygous deletions includes applying a predetermined threshold to separate homozygous deletions from non-homozygous deletions or amplifications. The vulnerability may include a metabolic vulnerability. Identifying the at least one respective vulnerability may include reviewing at least one of metabolic pathway data, signaling pathway data, and cell-cell communication pathway data. Identifying the vulnerability may include identifying whether the homozygous deleted gene and/or partner gene performs an essential function to a designated organism. The designated organism may include at least one of a yeast, a fly, a mouse, and a human.

In some embodiments, the method includes, prior to identifying the respective vulnerability, receiving selection of one or more pathway data sources. The pathway data sources may include a type of biological pathway. The pathway data sources may include one or more external databases. The method may include, prior to identifying the respective drug, receiving selection of one or more targeted drug data sources. The targeted drug data sources may include an identification of at least one of drug regulatory agency approved drugs and cancer drugs.

In some embodiments, the method includes, after providing the information, receiving verification results associated with a particular vulnerability of the at least one vulnerability and a particular drug, and storing the verification results for use in identifying drugs to inhibit partner genes of homozygous deletions. The method may include performing in vitro verification of the lethality of a particular drug to cells of the biological sample. Accessing genomic profile data of the biological sample may include accessing genomic profile data of a number of biological samples. Identifying the at least one vulnerability may include identifying, for each vulnerability of the at least one vulnerability, a number of samples exhibiting the respective vulnerability. The number of biological samples may include biological tissue samples obtained via one or more cancer studies.

In some embodiments, the biological sample is a cancer sample. The cancer sample may be from a patient having a carcinoma, sarcoma, myeloma, leukemia, or lymphoma.

In one aspect, the present disclosure relates to a system including a processor and a memory having instructions stored thereon, where the instructions, when executed by the processor, cause the processor to access genomic profile data for each biological sample of a number of biological samples and, for each biological sample, identify, within the respective genomic profile data, one or more homozygous deletions. The instructions, when executed, may cause the processor to, for at least a subset of biological samples of the number of biological samples, identify, for each homozygous deletion of a subset of the one or more homozygous deletions, at least one respective vulnerability, where identifying the respective vulnerability includes identifying, for the respective homozygous deletion, one or more partner genes as synthetic lethal for a cell of the biological sample, and identify, for each gene of a subset of the one or more partner genes of at least a first homozygous deletion of the subset of homozygous deletions, at least one respective drug known to inhibit the gene and/or a product of the gene. The instructions, when executed, may cause the processor to provide, for review by a medical professional, result information regarding one or more vulnerabilities and corresponding drugs identified in relation to at least one prospective biological sample of the number of biological samples.

In some embodiments, the at least one prospective biological sample includes a number of prospective biological samples, and the instructions, when executed, cause the processor to identify, for the number of prospective biological samples, one or more groups of biological samples each associated with a same homozygous deletion. The respective biological samples of each group of the one or more groups of biological samples may share a same tissue type. Providing the result information may include providing the result information grouped by the one or more groups.

In one aspect, the present disclosure relates to a non-transitory computer readable medium having instructions stored thereon, where the instructions, when executed by a processor, cause the processor to access genomic profile data of a biological sample, and identify, within the genomic profile data, one or more homozygous deletions. The instructions, when executed, may cause the processor to identify, for each homozygous deletion of a subset of the one or more homozygous deletions, at least one respective vulnerability, where identifying the respective vulnerability includes identifying, for the respective homozygous deletion, one or more partner genes as synthetic lethal for a cell of the biological sample. The instructions, when executed, may cause the processor to identify, for each gene of a subset of the one or more partner genes of at least a first homozygous deletion of the subset of homozygous deletions, at least one respective drug known to inhibit the gene and/or a product of the gene. The instructions, when executed, may cause the processor to provide, for review by a medical professional, information regarding the at least one vulnerability and the at least one respective drug.

In one aspect, the present disclosure relates to a method including obtaining a biological sample of cancer tissue, and analyzing the biological sample to obtain genomic profile data, where analyzing the biological sample includes performing at least one of a hybridization assay analysis and a genomic sequencing analysis. The method may include identifying, by a processor of a computing device, within the genomic profile data, one or more homozygous deletions, and identifying, by the processor, for each homozygous deletion of a subset of the one or more homozygous deletions, at least one respective vulnerability, where identifying the respective vulnerability includes identifying, for the respective homozygous deletion, one or more partner genes as synthetic lethal for a cell of the biological sample. The method may include identifying, by the processor, for each gene of a subset of the one or more partner genes of at least a first homozygous deletion of the subset of homozygous deletions, at least one respective drug known to inhibit the gene and/or a product of the gene. The method may include providing, by the processor, for review by a medical professional, information regarding the at least one vulnerability and the at least one respective drug.

In some embodiments, the information includes a recommended therapy. The information may include a recommended study.

In one aspect, the present disclosure relates to a method including accessing genomic profile data of a biological sample, and identifying, by a processor of a computing device, within the genomic profile data, one or more homozygous deletions or other disabling genetic or epigenetic alterations that eliminates or substantially reduces the function of a gene product. The method may include identifying, by the processor, for each homozygous deletion or other disabling genetic or epigenetic alteration of a subset of the one or more homozygous deletions or other disabling genetic or epigenetic alterations, at least one respective vulnerability, where identifying the respective vulnerability includes identifying, for the respective homozygous deletion or other disabling genetic or epigenetic alteration, one or more partner genes as synthetic lethal for a cell of the biological sample. The method may include identifying, by the processor, for each gene of a subset of the one or more partner genes of at least a first homozygous deletion or other disabling genetic or epigenetic alteration of the subset of homozygous deletions or other disabling genetic or epigenetic alterations, at least one respective drug known to inhibit the gene and/or a product of the gene. The method may include providing, by the processor, for review by a medical professional, information regarding the at least one vulnerability and the at least one respective drug.

In one aspect, the present disclosure relates to a system including a processor and a memory having instructions stored thereon, where the instructions, when executed by the processor, cause the processor to access genomic profile data for each biological sample of a number of biological samples, and, for each biological sample, identify, within the respective genomic profile data, one or more homozygous deletions or other disabling genetic or epigenetic alterations that eliminates or substantially reduces the function of a gene product.

The instructions, when executed, may cause the processor to, for at least a subset of biological samples of the number of biological samples, identify, for each homozygous deletion or other disabling genetic or epigenetic alteration of a subset of the one or more homozygous deletions or other disabling genetic or epigenetic alterations, at least one respective vulnerability, where identifying the respective vulnerability includes identifying, for the respective homozygous deletion or other disabling genetic or epigenetic alteration, one or more partner genes as synthetic lethal for a cell of the biological sample, and identify, for each gene of a subset of the one or more partner genes of at least a first homozygous deletion or other disabling genetic or epigenetic of the subset of homozygous deletions or other disabling genetic or epigenetic alterations, at least one respective drug known to inhibit the gene and/or a product of the gene. The instructions, when executed, may cause the processor to provide, for review by a medical professional, result information regarding one or more vulnerabilities and corresponding drugs identified in relation to at least one prospective biological sample of the number of biological samples.

In one aspect, the present disclosure relates to a non-transitory computer readable medium having instructions stored thereon, where the instructions, when executed by a processor, cause the processor to access genomic profile data of a biological sample, and identify, within the genomic profile data, one or more homozygous deletions or other disabling genetic or epigenetic alterations that eliminates or substantially reduces the function of a gene product. The instructions, when executed, may cause the processor to identify, for each homozygous deletion or other disabling genetic or epigenetic alteration of a subset of the one or more homozygous deletions or other disabling genetic or epigenetic alterations, at least one respective vulnerability, where identifying the respective vulnerability includes identifying, for the respective homozygous deletion or other disabling genetic or epigenetic alteration, one or more partner genes as synthetic lethal for a cell of the biological sample, and identify, for each gene of a subset of the one or more partner genes of at least a first homozygous deletion or other disabling genetic or epigenetic alteration of the subset of homozygous deletions or other disabling genetic or epigenetic alterations, at least one respective drug known to inhibit the gene and/or a product of the gene. The instructions, when executed, may cause the processor to provide, for review by a medical professional, information regarding the at least one vulnerability and the at least one respective drug.

In one aspect, the present disclosure relates to a method including obtaining a biological sample of cancer tissue, and analyzing the biological sample to obtain genomic profile data, where analyzing the biological sample includes performing at least one of a hybridization assay analysis and a genomic sequencing analysis. The method may include identifying, by a processor of a computing device, within the genomic profile data, one or more homozygous deletions or other disabling genetic or epigenetic alterations that eliminates or substantially reduces the function of a gene product. The method may include identifying, by the processor, for each homozygous deletion or other disabling genetic or epigenetic alteration of a subset of the one or more homozygous deletions or other disabling genetic or epigenetic alterations, at least one respective vulnerability, where identifying the respective vulnerability includes identifying, for the respective homozygous deletion or other disabling genetic or epigenetic alteration, one or more partner genes as synthetic lethal for a cell of the biological sample. The method may include identifying, by the processor, for each gene of a subset of the one or more partner genes of at least a first homozygous deletion or other disabling genetic or epigenetic alteration of the subset of homozygous deletions or other disabling genetic or epigenetic alterations, at least one respective drug known to inhibit the gene and/or a product of the gene. The method may include providing, by the processor, for review by a medical professional, information regarding the at least one vulnerability and the at least one respective drug.

In some embodiments, the at least one respective drug does not have on target detrimental effects to cells that do not harbor the homozygous deletion or other disabling genetic or epigenetic alteration. The disabling genetic alteration may include a mutation. The disabling epigenetic alteration may include hyper-methylation.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a process diagram of an example process for identifying metabolic vulnerabilities in biological samples;

FIG. 2 is a diagram of an example system for identifying metabolic vulnerabilities in biological samples;

FIG. 3 is a flow diagram of an example method for identifying metabolic vulnerabilities in biological samples;

FIGS. 4A through 4C illustrate screen shots of example result data identifying metabolic vulnerabilities and drugs that may be used to target a portion of the metabolic vulnerabilities;

FIGS. 5A and 5B illustrate a flow chart of an example method for identifying metabolic vulnerabilities in biological samples;

FIG. 6 is a block diagram of an example network environment for identifying metabolic vulnerabilities in biological samples; and

FIG. 7 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to one or more systems, methods, and apparatus for identifying vulnerabilities within cancer cells due to homozygous deletion of one or more genes having known synthetic lethals. As used herein, the term “cancer cell” refers to both cancerous and precancerous cells. By identifying one or more drugs known to inhibit each partner gene (e.g., synthetic lethal) of a homozygous deletion, a targeted drug therapy can be supplied to a patient that, while proving lethal to the targeted cancer cells, will not destroy healthy (e.g., noncancer) cells because a partner gene (e.g., the one homozygously deleted within the tumor) will remain to perform the essential function.

In order to exploit vulnerabilities of cancer cells on the basis of homozygous deletion, a genomic profile of cancer cells in a biological sample (e.g., obtained via biopsy of a tumor, bone marrow, etc.) is analyzed to identify homozygous deletions of one or more genes. The homozygous deletions, in turn, are analyzed in view of pathway data (e.g., metabolic, signaling, and/or cell-to-cell communication pathway data obtained from one or more databases) to determine a subset of homozygous deletions in a core cellular pathway (e.g., performing a core function considered to be necessary to the viability of the cell). From this subset of homozygous deletions, cellular pathway data is analyzed to identify one or more partner genes (e.g., synthetic lethals) considered to facilitate or perform the same or similar function as the respective homozygous deletion. Drug annotations (e.g., obtained from one or more external resources), in turn, may be reviewed to identify drugs that inhibit at least one of the synthetic lethal genes and/or gene products. One or more of the identified drugs may then be used in validation tests (e.g., in vitro laboratory tests against one or more cell lines having the identified homozygous deletion) to confirm specific lethality to cancer cells.

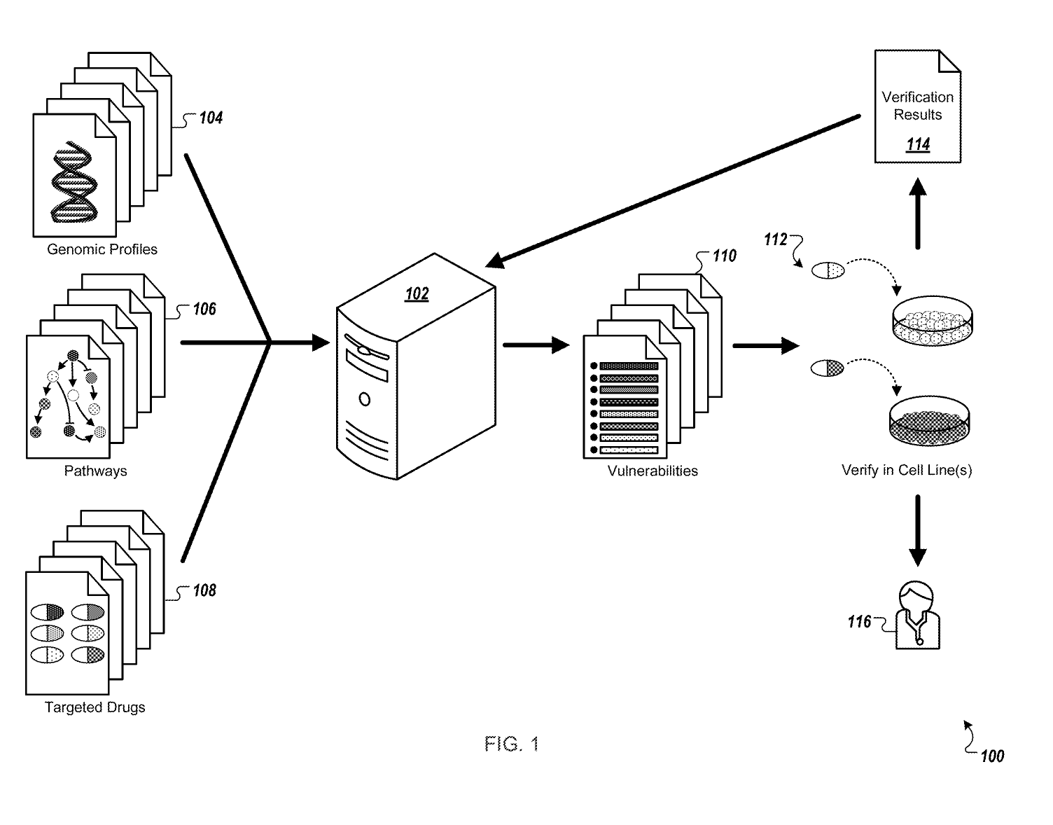

Turning to FIG. 1, a process diagram illustrates an example process 100 for identifying vulnerabilities in biological samples using an analysis system 102 (e.g., one or more computing devices). The analysis system 102 accesses genomic profile data 104, pathway data 106, and drug data 108 to match one or more targeted drugs to an identified pathway vulnerability 110 in the genomic profile data 104.

The process 100, in some implementations, begins with importing pathway data 106 and drug data 108 from one or more external databases. For example, public databases, such as the DrugBank database of the University of Alberta, the KEGG Enzyme Database maintained by Kanehisa Laboratories of Kyoto University Bioinformatics Center Kyoto, Genomics of Drug Sensitivity in Cancer Database (GDSC) maintained by the Sanger Institute of Hinxton, GB and Massachusetts General Hospital Cancer Center of Boston, Mass., the drug annotation database records maintained by the National Cancer Institute of Rockville, Md., Pathway Commons maintained by the Memorial Sloan-Kettering Cancer Center, the Tissue-specific Gene Expression and Regulation (TiGER) database developed by the Bioinformatics Lab at Wilmer Eye Institute of Johns Hopkins University, the HumanCyc Encyclopedia of Homo Sapiens Genes and Metabolism maintained by SRI International of Menlo Park Calif., and the Reactome pathway database (a collaboration among groups at the Ontario Institute for Cancer Research, Cold Spring Harbor Laboratory, New York University School of Medicine and The European Bioinformatics Institute), may be mined to obtain recent information regarding cellular pathways and drugs that inhibit particular gene expression. In some implementations, the pathway data 106 is formatted using the Biological Pathway Exchange (BioPAX) standard language. The pathway data 106 and/or the drug data 108, upon importation, may be reformatted to a standard format used by the analysis system 102.

In some implementations, genomic profile data 104 regarding one or more genomic profiles is imported. The genomic profile data 104 includes data obtained from a biological sample, such as a tumor biopsy. The genomic profile data 104, for example, may include Copy Number Alteration (CNA) or Copy Number Variation (CNV) data obtained through virtual karyotyping with SNP arrays, such as the Affymetrix Genome-Wide Human SNP 6.0 array by Affymetrix of Santa Clara, Calif. In other examples, the genomic profile data 104 may include data obtained as biological sequencing output from a next generation medical sequencer (e.g., paired-end sequencing, high throughput sequencing, etc.) or from other cytogenetic techniques such as fluorescent in situ hybridization (FISH), comparative genomic hybridization (CGH), or array comparative genomic hybridization (ACGH). In some implementations, the genomic profile data 104 includes raw data (e.g., in the format output by a medical sequencer or un-interpreted array data). For example, the analysis system 102 may include a deletion analyzer for analyzing raw data to obtain CNA/CNV output. In some examples, CNA data may be obtained from raw microarray data using the RAE computational approach developed by Memorial Sloan-Kettering Cancer Center of New York, N.Y., Genomic Identification of Significant Targets in Cancer (GISTIC) developed by the Broad Institute of Cambridge, Mass., or the Predicting Integral Copy Numbers in Cancer (PICNIC) algorithm by the Sanger Institute of Hinxton, GB.

In some implementations, the genomic profile data 104 includes aligned data. The data, for example, may be obtained from a cancer study center such as the cBioPortal for Cancer Genomics maintained by the Memorial Sloan-Kettering Cancer Center of New York, N.Y. The genomic profile data 104, in some examples, may include data for identifying loss of heterozygosity such as copy number alteration (CNA) data (detected, for example, using Allele-Specific Copy number Analysis of Tumors (ASCAT) by Peter Van Loo et al., Genome Alteration Print (GAP) by Tatiana Popova of the Institut Curie Paris, GenoCN by Wei Sun of the UNC Gillings School of Global Public Health, Global Parameter Hidden Markov Model (GPHMM) by the Department of Electronic Science and Technology of USTC, MixHMM maintained by Yale University, and/or OncoSNP developed at the Department of Statistics at the University of Oxford) and/or gene expression data (detected, for example, using the Babelomics 4 Gene Expression and Functional Profiling Analysis Suite by the CIPF Bioinformatics and Genomics Department, BiNGO: a Biological Networks Gene Ontology tool by Ghent University of Belgium, CLASSIFI—Cluster Assignment for Biological Inference by UT Southwestern Medical Center Department of Pathology, EGAN: Exploratory Gene Association Networks by the UCSF Helen Diller Family Comprehensive Cancer Center Biostatistics Core, GOEAST—Gene Ontology Enrichment Analysis Software Toolkit by the Chinese Academy of Sciences Beijing, GoEx—Gene Ontology Explorer by the Scripps Research Institute—Yates Lab, GOMO—Gene Ontology for Motifs by the University of Queensland Brisbane, the Gene Ontology Browsing Utility (GOBU) of the Academia Sinica of Taipei, Network Ontology Analysis by the Chinese Academy of Sciences Beijing, Onto-Express by Wane State University Michigan, and/or OntoGate by the Max-Planck-Institute for Informatics of Saarbrucken, Ontologizer by Charite—Universitatsmedizin Berlin). In some implementations, the analysis system 102 includes one or more modules for generating copy number alteration data and/or gene expression data from the genomic profile data 104.

In some implementations, the analysis system 102 analyzes the genomic profile data 104 to identify one or more homozygous deletions. The analysis system 102 may cross-reference the identified homozygous deletions with the pathway data 106 to identify one or more deletions associated with partners known or suspected to be synthetic lethal for a cell.

In some implementations, prior to cross-referencing, the analysis system 102 cross-references the pathway data 106 with the drug data 108 to identify synthetic lethal sets for which at least one known inhibiting drug exists. In some implementations, the drug data 108 includes only regulatory board-approved drugs (e.g., U.S. Food and Drug Administration (FDA) approved, etc.). In some implementations, the analysis system 102 filters the drug data 108, for example to identify those drugs which have received approval for use in humans or for use in cancer treatment.

In some implementations, after identifying one or more deletions associated with synthetic lethal partners, the analysis system 102 identifies one or more drugs within the drug data 108 which are known or suspected to inhibit at least one of the synthetic lethal partners. For example, drug data may be reviewed to identify those drugs predicted to inhibit remaining (active) partner genes.

In some implementations, the analysis system 102 outputs vulnerabilities 110 identified within the genomic profile data 104. The vulnerabilities 110, for example, may include a listing of homozygous deletions, associated synthetic lethal partners, and drugs identified as being capable of inhibiting at least a portion of the synthetic lethal partners. The output, for example, may include a graphical user interface for reviewing, sorting, searching, and/or drilling down into information regarding the identified vulnerabilities 110.

In some implementations, the vulnerabilities 110 are analyzed to identify most promising candidates to suppress cancer proliferation. For example, the vulnerabilities 110 may be scored, ranked, and/or grouped depending upon a number of factors. For example, each homozygous deletion—synthetic lethal combination may be analyzed based upon drug selection-qualifying data, such as a number of drugs required (e.g., one drug targeted to one partner vs. two drugs, each targeted to one of two partners, etc.), whether a given drug is believed to inhibit expression one or more additional genes, and/or whether each targeted drug has obtained drug regulatory agency approval (e.g., FDA approval, cancer treatment approval, etc.). In another example, each homozygous deletion—synthetic lethal combination may be analyzed based upon synthetic lethal selection-qualifying data, such as whether the function performed by the homozygous deletion is deemed a core function (e.g., essential to the viability of the cell), whether the function performed by the homozygous deletion is deemed an essential function (e.g., essential to the viability of the organism), whether expression of a particular partner gene to the homozygous deletion is tissue-specific, etc. Identification of core and/or essential functions, for example, may be supported through accessing information provided by the Database of Essential Genes (DEG) maintained by the Centre of BioInformatics of Tianjin University.

In some implementations, one or more drug therapies are identified from the vulnerabilities 110 for laboratory (e.g., in vitro) verification 112. For example, biological samples may be exposed to selected drug therapies to identify whether the drug therapy succeeds in lethality to the targeted cells. In some implementations, verification is performed against one or more cell lines, such that a confidence factor of the results is increased. In some implementations, verification is performed against two or more cell lines, such that a confidence factor of the results is further increased.

In some implementations, verification results 114 are obtained. The verification results 114, for example, may be shared with the medical community, used by a medical professional to prescribe a personalized therapy for a particular patient, or identified for a broader research study into the applicability of the drug therapy in treatment of eligible patients (e.g., patients whose biological samples exhibit the particular homozygous deletion). In some implementations, the verification results 114 are fed back into the analysis system 102. For example, should the verification results 114 identify success in relation to a single cell line, the analysis system 102 may store the information for future reference when verifying against a second cell line or when verifying a different drug therapy for a genomic profile having a same homozygous deletion.

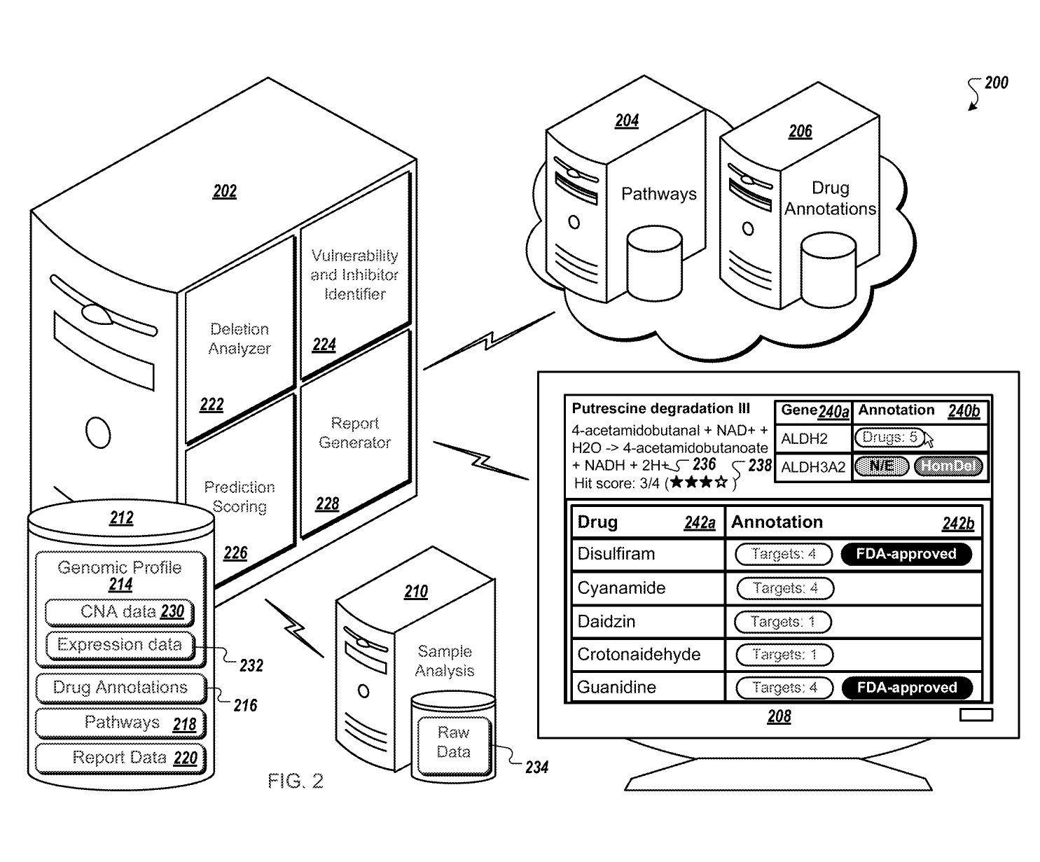

Turning to FIG. 2, an example system 200 for identifying vulnerabilities in biological samples includes a vulnerability identification and analysis system 202 in communication with one or more pathway data sources 204 and one or more drug annotation sources 206. The vulnerability identification and analysis system 202 accesses genomic profile data 214 of a biological sample and identifies vulnerabilities within the genomic profile data 214 using a vulnerability and inhibitor identification module 224 that references pathway data 218 to identify synthetic lethal partners of genes homozygously deleted from the genomic profile data. The vulnerability and inhibitor identification module 224 cross-references the identified synthetic lethal partners with drug annotation data 216 to determine a drug therapy for inhibiting the functionality of the synthetic lethal partners of each homozygously deleted gene. This information, in turn, may be weighted, ranked, or otherwise organized to promote most promising drug therapies by a prediction scoring module 226. The vulnerability information (e.g., drug therapies to inhibit the activities of synthetic lethals of the homozygously deleted genes) is then organized for end user review by a report generating module 228. For example, the report generating module 228 may prepare a report for review on a display 208.

In some implementations, the vulnerability identification and analysis system 202 collects up-to-date pathway data (e.g., metabolic pathways, signaling pathways, cell-cell communication pathways, etc.) from one or more external pathway data sources 204 and collecting up-to-date drug annotation data from one or more external drug annotation sources 206. For example, public databases, such as the DrugBank database of the University of Alberta, the KEGG Enzyme Database maintained by Kanehisa Laboratories of Kyoto University Bioinformatics Center Kyoto, Pathway Commons maintained by the Memorial Sloan-Kettering Cancer Center, the Tissue-specific Gene Expression and Regulation (TiGER) database developed by the Bioinformatics Lab at Wilmer Eye Institute of Johns Hopkins University, the HumanCyc Encyclopedia of Homo Sapiens Genes and Metabolism maintained by SRI International of Menlo Park Calif., Reactome pathway database (a collaboration among groups at the Ontario Institute for Cancer Research, Cold Spring Harbor Laboratory, New York University School of Medicine and The European Bioinformatics Institute), and the Cancer Cell Line Encyclopedia maintained by the Broad Institute, may be mined to obtain recent information regarding cellular pathways and drugs that inhibit particular gene expression. The information, for example, may be stored within a local data store 212 (e.g., in wired or wireless communication with the vulnerability identification and analysis system 202, for example via a Local Area Network (LAN) or Wide Area Network (WAN)). In some implementations, data collected from the external pathway data sources 204 and/or the external drug annotation sources 206 is reformatted prior to storage in the local data store 212. For example, depending upon the source of the drug annotation data 216 and/or the pathway data 218, the data may be reformatted into a common format for storage and reference as drug annotation data 216 and pathway data 218 in the local data store 212. For example, the pathway data 218 may be formatted using the Biological Pathway Exchange (BioPAX) standard language.

In some implementations, the vulnerability identification and analysis system 202 retrieves a portion of drug annotation data available from the one or more drug annotation sources 206. In some examples, the drug annotation data 216 may be limited to drug regulatory agency approved drugs, cancer drugs, and/or drugs which are not identified as being “illicit” or “withdrawn”. In another example, the drug annotation data 216 may be limited to drugs including target information (e.g., a target gene, a target encoding product such as enzymes or other polypeptides, etc.).

In some implementations, the vulnerability identification and analysis system 202 receives genomic profile data 214 from a biological sample analysis system 210. The sample analysis system 210, in some examples, may perform biological sequencing on the biological sample (e.g., using a next generation medical sequencer) or perform other cytogenetic techniques such as fluorescent in situ hybridization, comparative genomic hybridization, or array comparative genomic hybridization. The data obtained from the sample analysis system 210, for example, may be provided in a raw data format 234, and the vulnerability identification and analysis system 202 may generate CNA, CNV, and/or expression data based upon the raw data 234, for example using a deletion analysis module 222. The vulnerability identification and analysis system 202, in some implementations, generates or imports (e.g., retrieves from an external source) genomic profile data 214 including at least one of copy number alteration (CNA) data 230 and expression data 232. For example, the deletion analysis module 222 may analyze the raw data 234 (or aligned/interpreted data obtained from the raw data 234) to obtain data for identifying loss of heterozygosity such as the CNA data 230 (detected, for example, using Allele-Specific Copy number Analysis of Tumors (ASCAT) by Peter Van Loo et al., Genome Alteration Print (GAP) by Tatiana Popova of the Institut Curie Paris, GenoCN by Wei Sun of the UNC Gillings School of Global Public Health, Global Parameter Hidden Markov Model (GPHMM) by the Department of Electronic Science and Technology of USTC, MixHMM maintained by Yale University, and/or OncoSNP developed at the Department of Statistics at the University of Oxford) and/or the gene expression data 232 (detected, for example, using the Babelomics 4. Gene Expression and Functional Profiling Analysis Suite by the CIPF Bioinformatics and Genomics Department, BiNGO: a Biological Networks Gene Ontology tool by Ghent University of Belgium, CLASSIFI—Cluster Assignment for Biological Inference by UT Southwestern Medical Center Department of Pathology, EGAN: Exploratory Gene Association Networks by the UCSF Helen Diller Family Comprehensive Cancer Center Biostatistics Core, GOEAST—Gene Ontology Enrichment Analysis Software Toolkit by the Chinese Academy of Sciences Beijing, GoEx—Gene Ontology Explorer by the Scripps Research Institute—Yates Lab, GOMO—Gene Ontology for Motifs by the University of Queensland Brisbane, the Gene Ontology Browsing Utility (GOBU) of the Academia Sinica of Taipei, Network Ontology Analysis by the Chinese Academy of Sciences Beijing, Onto-Express by Wane State University Michigan, and/or OntoGate by the Max-Planck-Institute for Informatics of Saarbrucken, Ontologizer by Charite—Universitatsmedizin Berlin).

Using the genomic profile data 214 including the information regarding the loss of heterozygosity (e.g., CNA data 230 and/or expression data 232), in some implementations, the vulnerability and inhibitor identifier 224 identifies one or more homozygously deleted genes. Using the pathway data 218, the homozygous deletions may be matched to one or more synthetic lethals (e.g., partner genes performing a same or similar function or process as the homozygous deletion). Due to the homozygous deletion, the biological sample (e.g., cancer cells) may be vulnerable to a drug therapy targeting these partner genes, because, in healthy cells, even upon inhibiting the one or more partner genes, the cell would continue to perform the function or process because the healthy cell lacks the homozygous deletion.

In some implementations, the deletion analysis module 222 reviews gene expression data related to the homozygous deletions. For example, the deletion analysis module 222 may determine whether a gene expression level of an identified homozygous deletion is under-expressed or not expressed. In this manner, for example, the deletion analysis module 222 may separate suspected homozygous deletions from genetic expression levels more indicative normal expression or of amplifications. In a particular example, the deletion analysis module 222 may apply a predetermined threshold to separate homozygous deletions from normal levels of expression or amplifications.

In some implementations, the vulnerability identification and analysis system 202 matches each identified homozygous deletion with one or more synthetic lethal partner genes. Using the pathway data 218, for example, the vulnerability and inhibitor identification module 224 may identify synthetic lethal genes associated with the homozygously deleted gene. In some implementations, the vulnerability and inhibitor identifier may only identify those synthetic lethals known to be functional within a tissue type of the biological sample. For example, expression of certain genes may be tissue specific such that, if the biological sample has a known tissue type, the vulnerability and inhibitor identifier 224 may ignore those synthetic lethals not expressed for that tissue type (e.g., only expressed in one or more tissue types different than the tissue type of the biological sample). If the particular synthetic lethal gene is not expressed in the tissue type of the biological sample, there would be no need to inhibit that particular synthetic lethal (or a product or process thereof). In other implementations, the vulnerability identification and analysis system 202 collects information from the pathway data 218 regarding tissue specificity of particular synthetic lethal genes, for example for use by the prediction and scoring module 226 or as additional information for presentation to a user in a report created by the report generating module 228).

In some implementations, prior to identifying synthetic lethal(s) associated with each homozygous deletion, the vulnerability identification and analysis system 202 cross-references each homozygous deletion with pathway data 218 to identify whether the homozygously deleted gene performs a process or generates a product necessary to the viability of the cell and/or the viability of the organism. For example, in targeting synthetic lethal(s) of a homozygously deleted gene identified as being essential to cell viability, the inhibition of the associated process or product may lead to cell death. However, if a process or product necessary to the viability of an organism is targeted, the drug treatment may be toxic to the patient. Thus, identifying (and avoiding) inhibiting those products and/or processes necessary to the viability of an organism may be prudent. In this manner, prior to identifying synthetic lethals, the total number of homozygous deletions may be reduced to those homozygous deletions of greatest interest (e.g., those which are most likely to eradicate cancer cells while not causing damage to the patient). In other implementations, the vulnerability identification and analysis system 202 collects information regarding core genes (e.g., performing functions or producing products essential to the viability of the cell) and essential genes (e.g., performing functions or producing products essential to the viability of an organism) upon matching homozygous deletions to synthetic lethals, for example for use by the prediction and scoring module 226 or as additional information for presentation to a user in a report created by the report generating module 228). In some implementations, the essential genes may relate to data collected regarding an organism different than the organism associated with the biological sample. For example, while the biological sample may be obtained from a human, the particular gene may be identified as being essential to a different organism such as a yeast, a fly, or a mouse. In other implementations, essential gene information from the same type of organism is obtained (e.g., human essential gene designations).

Once the synthetic lethal(s) have been identified, in some implementations, the vulnerability and inhibitor identifier 224 reviews the drug annotation data 216 to determine, for each synthetic lethal, if one or more drugs are known to inhibit the synthetic lethal gene or a product/process thereof. In some implementations, the vulnerability and inhibitor identifier 224 gathers, for each identified drug, drug selection factors such as, in some examples, all known targets of the drug (e.g., in addition to the target of the associated synthetic lethal), a drug regulatory agency approval status, and a drug regulatory approval status related to cancer indication.

In some implementations, the synthetic lethal and drug inhibitor data collected by the vulnerability and inhibitor identification module 224 is provided to the prediction scoring module 226 to assess the identified candidate therapies for exploiting the vulnerabilities exposed through homozygous deletion. The prediction scoring module 226, for example, may assess (e.g., rank, score, order, etc.) each homozygous deletion-synthetic lethal combination based upon a number of factors such as drug selection factors (e.g., drug regulatory agency approval status, drug regulatory agency approval for cancer indication, and number of additional targets modulated by the drug), a number of synthetic lethals and/or number of drugs needed to inhibit the total number of synthetic lethals (e.g., one drug per synthetic lethal, a single drug inhibits two or more synthetic lethals, etc.), and vulnerability selection factors (e.g., whether a particular synthetic lethal is an essential gene, whether a particular synthetic lethal performs a core pathway function, whether a particular synthetic lethal has a tissue-specific designation matching the tissue type of the biological sample, etc.).

In some implementations, the candidate therapies identified by the vulnerability and inhibitor identification module 224 (and, in some embodiments, assessed via the prediction scoring module 225), are provided to the report generation module 228 for creating report data for review by a user (e.g., laboratory technician, medical professional, etc.). For example, the display 208 illustrates example report output including an upper region identifying a metabolic reaction 236, a score 238 (e.g., as calculated by the prediction scoring module 226), and identification of partner gene(s) 240a and associated gene annotations 240b.

According to the analysis of a particular genomic profile 214, a homozygous deletion of gene ALDH3A2 (identified in the gene annotation column 240b with the marking “HomDel”) has been matched with partner gene ALDH2. The metabolic reaction 236 performed by genes ALDH2 and ALDH3A2 is Putrescine degradatation III (4-acetamidobutanal+NAD++H₂O->4-acetamidobutanoate+NADH+2H+). A not expressed (“N/E”) annotation 240b confirms that the gene ALDH3A2, in addition to being identified as a homozygous deletion through analysis of gene profile data 214, has been identified as not expressed according to the corresponding expression data 232. Five drugs have been identified as inhibiting the metabolic reaction 236 of the partner gene ALDH2. According to a hit score 238, the potential for therapeutic success involving inhibiting the metabolic reaction 236 of gene ALDH2 with one of the identified target drugs is scored at three out of four stars.

In some implementations, the hit score 238 is determined based upon a series of points allocated in relation to the information identified corresponding to the metabolic reaction 236. For example, if the metabolic reaction 236 is considered to perform a core function (e.g., essential to the viability of the cell), the hit score 238 may gain a point. However, if the metabolic reaction 236 is considered to perform an essential function (e.g., essential to the viability of the target organism), the hit score 238 may lose a point (e.g., anticipated toxicity to the subject if provided such a therapy).

In another example, if the analysis system 202 fails to identify a target drug 242 for inhibiting the function of at least one partner gene 240a, the hit score 238 may lose a point. Conversely, if at least one drug 242 is identified per partner gene 240a, and that drug 242 has obtained drug regulatory agency approval, the hit score 238 may gain a point.

In some implementations, if the suspected homozygous deletion ALDH3A2 is identified as not being expressed via analysis of the expression data 232 (as illustrated by the “N/E” annotation 240b), the hit score 238 may gain a point. Conversely, if the suspected homozygous deletion were to be identified as being expressed according to analysis of the expression data 232, the hit score 238 may lose a point.

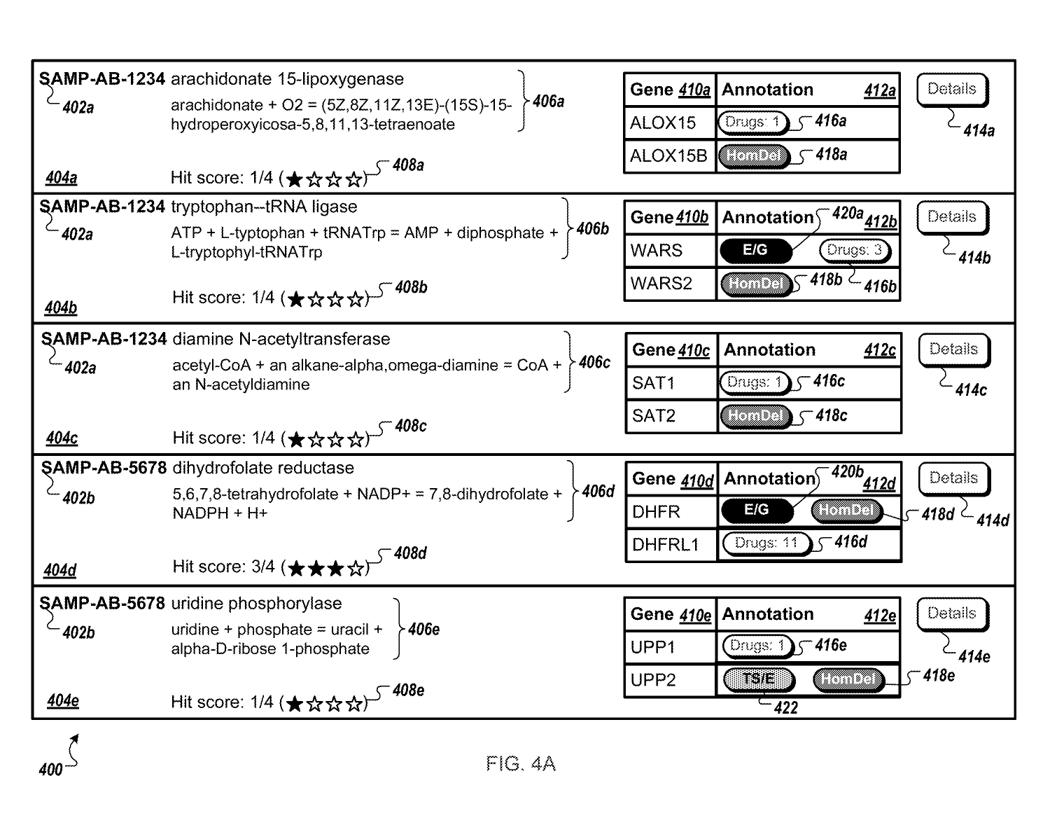

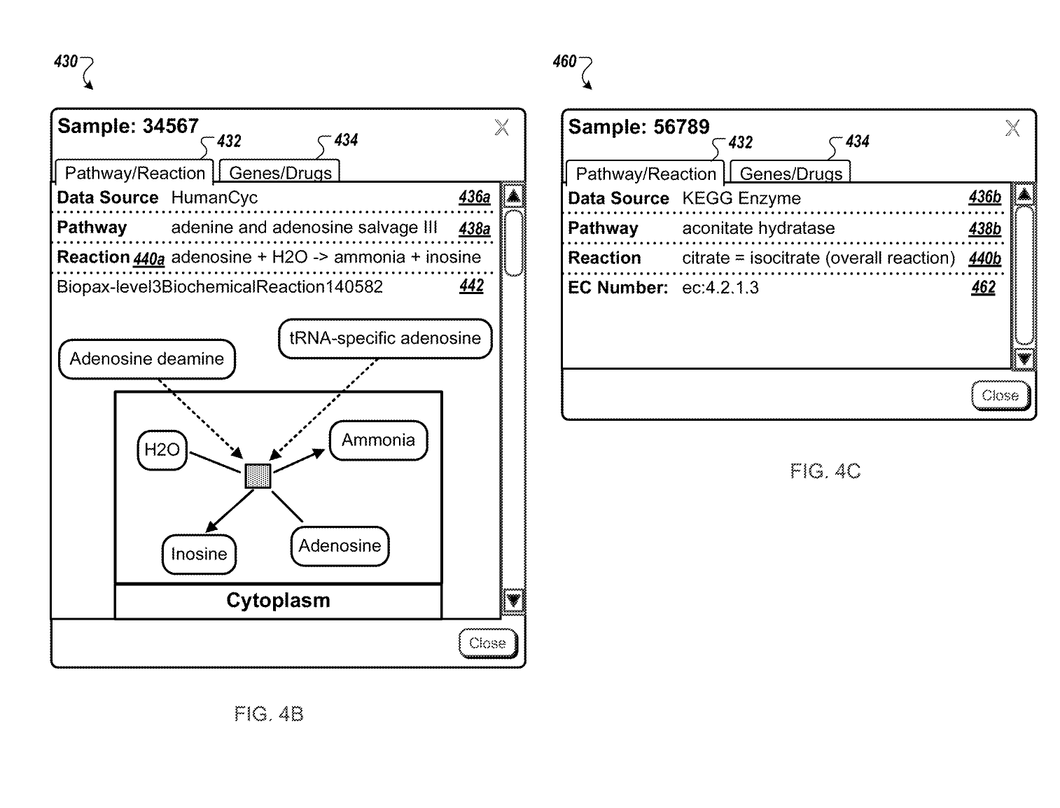

Although described in relation to single point analysis, in some implementations, the hit score 238 is calculated based upon weighted analysis of the annotation data 240b. For example, FDA-approval of a drug may be weighted in one manner, while FDA approval of a drug in use as a cancer treatment may be weighted in a separate (e.g., stronger) manner Other scoring factors and methods are possible. Report data is described in greater detail in relation to FIGS. 4A through 4C, below.

Beneath the metabolic reaction 236 and gene annotation 240 information, a lower region of the report data provides a detailed view regarding targeted drugs 242a and associated drug annotations 242b. Within the annotation column 240b above, for example, gene ALDH2 is associated with five target drugs. As listed in the targeted drugs column 242a, the five target drugs are Disulfiram, Cyanamide, Daidzin, Crotonaidehyde, and Guanidine. Of the target drugs, Disulfiram and Guanidine are each identified as having drug regulatory agency approval (e.g., “FDA-approved”). The FDA-approval for each of the drugs Disulfiram and Guanidine, for example, may contribute to a higher hit score 238. However, each of the target drugs Disulfiram and Guanidine are identified as having four separate targets, meaning that, in addition to inhibiting the function of gene ALDH2, they each are known to inhibit three additional genes. In some implementations, a number of additional targets may have a negative impact upon the hit score 238. In some implementations, the prediction scoring module 226 may identify annotations regarding the additional target genes of a target drug such as Disulfiram and Guanidine, for example to determine whether the additional target genes perform core functions and/or essential functions.

In some implementations, the report data illustrated within the display 208 is interactive such that, upon selection of particular fields, additional information is supplied to a user. Examples of drill-down report data are provided in FIGS. 4B and 4C. The report data may be accessed by the report generation module 228, for example, from a report data repository 220.

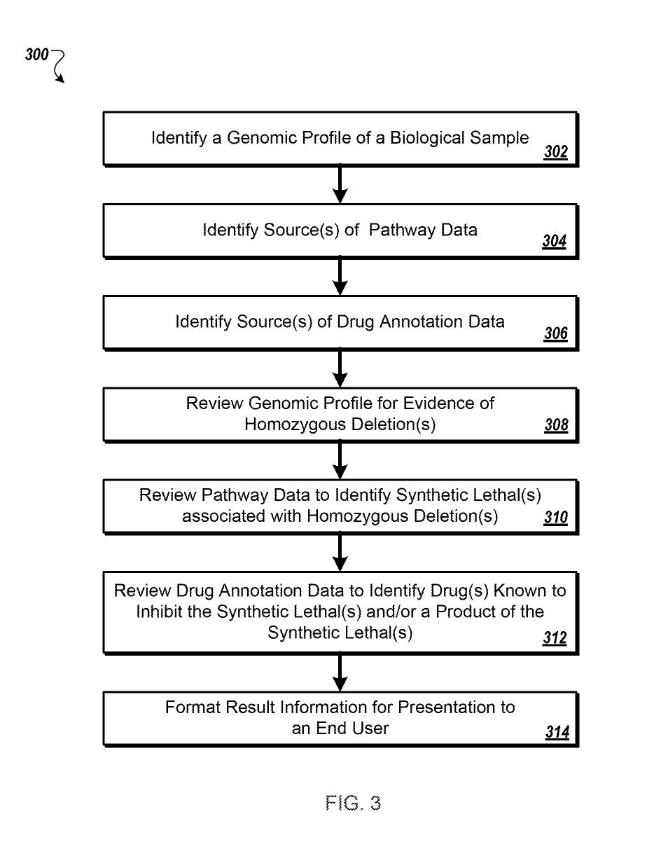

FIG. 3 is a flow diagram of an example method 300 for identifying vulnerabilities in biological samples. The method 300, for example, may be performed by the vulnerability identification and analysis system 202.

In some implementations, the method begins with identifying a genomic profile of a biological sample of a subject (302). The genomic profile, for example, may include data obtained through virtual karyotyping with SNP arrays, such as the Affymetrix Genome-Wide Human SNP 6.0 array by Affymetrix of Santa Clara, Calif. In other examples, the genomic profile data may include data obtained as biological sequencing output from a next generation medical sequencer or from other cytogenetic techniques such as fluorescent in situ hybridization, comparative genomic hybridization, or array comparative genomic hybridization. In some implementations, the genomic profile includes CNA (or CNV) data and/or gene expression profile data. The genomic profile data, in some implementations, is associated with a particular tissue type (e.g., the biological sample includes particular tissue sample).

In some implementations, one or more sources of pathway data are identified (304). The pathway data, in some examples, may include metabolic pathway data, signaling pathway data, and/or cell-cell communication pathway data. Information contained within the pathway data, in some examples, can include identification of synthetic lethality sets (e.g., groupings of genes which perform the same function or produce a substantially identical product for a cell), identification of expression patterns (e.g., genes which are expressed only in specific tissues, etc.), identification of genes performing core functions (e.g., essential to the viability of a cell), identification of genes performing essential functions (e.g., essential to the viability of a designated organism), and identification of particular reactions particular genes are involved in. In some implementations, the pathway data is collected from one or more external database systems, as described above in relation to FIG. 1. The pathway data, in some implementations, is converted to a standard format and stored within a local database system for reference.

In some implementations, one or more sources of drug annotation data are identified (306). The drug annotation data, in some examples, may include identification of drug regulatory agency approval, approval for use in treatment of cancer, one or more active studies available for drugs pending approval, and/or a withdrawn (e.g., loss of regulatory agency approval) status. In some implementations, the drug annotation data includes identification of gene target information such as, in some examples, a number of targets (e.g., genes inhibited by the drug), and an identification of particular genes, metabolic reactions, gene expression products, and/or or pathway functions inhibited by the drug. In some implementations, the drug annotation data is collected from one or more external database systems, as described above in relation to FIG. 1. The drug annotation data, in some implementations, is converted to a standard format and stored within a local database system for reference.

In some implementations, the genomic profile is reviewed for evidence of one or more homozygous deletions (308). For example, CNA or CNV data may be reviewed to identify one or more genes missing due to homozygous deletion. The identified homozygous deletions, in some implementations, are cross-referenced with gene expression profile data to determine whether or not the suspected deletion is expressed by the sample. In this manner, the method 300 may attempt to confirm that a gene suspected of deletion has been deleted.

In some implementations, the pathway data is reviewed to identify one or more synthetic lethal partners associated with each homozygous deletion (310). Synthetic lethal partners, for example, may perform a similar function or create a similar product to the gene which has been identified as being homozygously deleted. If the gene profile includes a tissue specific designation, in some implementations, the pathway data is reviewed to identify one or more synthetic lethal partners expressed within the particular tissue type. For example, should a synthetic lethal to the homozygous deletion fail to be expressed within a particular tissue type of the biological sample, targeting a therapeutic treatment to the unexpressed gene would likely fail to damage the cell. Likewise, if one of a plurality of partner genes is not typically expressed in the tissue type containing the homologous deletion (i.e., there are two or more synthetic lethal partner genes but only one of the partner genes is expressed in normal cells of the tissue type sought to be killed), then a target drug or drugs may be successfully lethal by inhibiting fewer than all of the known partner genes or gene products. For example, if gene X is homozygously deleted in cancer cells of a biological sample from liver, and partner genes 1 and 2 are expressed in one or more other tissue types but only partner gene 1 is expressed in normal liver cells (i.e., partner gene 2 is specifically expressed in other tissues), then a drug need only target partner gene 1 (as opposed to targeting both partner genes 1 and 2) to be lethal to cancer cells of liver origin.

In some implementations, each homozygous deletion is reviewed in light of the pathway data to determine whether the homozygously deleted gene is identified as performing a core function (e.g., essential to the viability of a cell) or an essential function (e.g., essential to the viability of a designated organism). For example, the homozygous deletions may be reviewed to identify one or more homozygous deletions which cause a cell to be vulnerable to a drug therapy targeting synthetic lethals of the homozygous deletion (e.g., a core gene), while not causing toxicity to the organism (e.g., not an essential gene). In some implementations, pathway annotation data (e.g., tissue-specificity, core function designation, essential function designation, etc.) is collected for later reference. For example, the pathway annotation data may be provided to a user in report data and/or used as selection factors in determining relative likelihood of success of two or more proposed homozygous deletion vulnerabilities to attack using a drug therapy.

In some implementations, drug annotation data is reviewed to identify one or more drugs known to inhibit each identified synthetic lethal (or a product thereof) (312). The drug annotation data, for example, may be reviewed to identify one or more drugs which can be used as a therapy to attack cells exhibiting a particular homozygous deletion by inhibiting any and all synthetic lethals of the particular homozygous deletion (or at least those synthetic lethals identified as being expressed within the tissue type of the biological sample). In some implementations, drug annotation data (e.g., drug regulatory agency approval, approval as a cancer therapy, a withdrawn status, one or more available studies related to the drug, one or more additional genes targeted by the drug, etc.) is collected for later reference. For example, the drug annotation data may be provided to a user in report data and/or used as selection factors in determining relative likelihood of success of two or more proposed homozygous deletion vulnerabilities to attack using a proposed drug therapy.

In some implementations, information regarding the homozygous deletion(s), synthetic lethal(s), and one or more proposed drug therapies are formatted as result information for presentation to an end user (314). Example report data is illustrated in relation to FIGS. 4A through 4C. The report data, in some implementations, is sorted and/or arranged based at least in part upon a prediction scoring mechanism which reviews the pathway annotation data and drug annotation data to identify most likely drug therapies for exploiting one or more vulnerabilities identified within the biological sample (e.g., cancer cells) due to homozygous deletion.

Turning to FIG. 4A, an example report page 400 includes a series of records 404 regarding analysis of two biological samples 402. The report page 400, for example, may be a snapshot of a greater number of records presented in relation to reviewing a large number of genomic profiles associated with a cancer study (e.g., obtained from a cancer study center). In a particular example, the genomic profile data may be accessed from the cBioPortal for Cancer Genomics maintained by the Memorial Sloan-Kettering Cancer Center of New York, N.Y.

Each record 404 identifies a metabolic reaction 406 catalyzed by the set of genes 410 (e.g., a homozygously deleted gene 418 labeled “HomDel” plus one or more synthetic lethals), a set of annotations 412 regarding the homozygous deletion-synthetic lethal sets of genes 410, and a score 408 (e.g., prediction of the usefulness of the one or more identified drugs 416 in attacking the cancer of the sample 402). The score 408 may be based at least in part upon the information available within the annotations 412. For example, the second record 404b identifies that the synthetic lethal gene 410b (WARS) is an essential gene 420a. Thus, inhibiting the WARS gene may have an unintended consequence of toxicity to the organism. In another example, the homozygously deleted gene 410e (UPP2) is marked as having tissue-specific expression 422. If the gene is not expressed within the tissue type of the sample 402b, it may not be worthwhile to target the UPP1 synthetic lethal 410e.

Additionally, each record 404 includes a details button 414 which, upon selection, may present additional information to the user. Upon selection of one of the details buttons 414, for example, the user may be presented with additional information regarding one or more of the metabolic reaction 406, the one or more target drugs 416 proposed to inhibit one or more synthetic lethal genes 410, and sources of the information presented (e.g., identification of one or more pathway data sources and/or drug annotation data sources). Examples of screen shots containing additional information are provided in FIGS. 4B and 4C.

Turning to FIGS. 4B and 4C, both a first screen shot 430 and a second screen shot 460 illustrate pop-up window style displays regarding pathway/reaction data 432 related to two different homozygously deleted genes. The screen shot 430 of FIG. 4B, for example, identifies that a pathway adenine and adenosine salvage III 438a described in the HumanCyc data source 436a (e.g., the HumanCyc Encyclopedia of Homo Sapiens Genes and Metabolism maintained by SRI International of Menlo Park Calif.) is associated with a reaction 440a of adenosine+H₂O->ammonia+inosine. A reaction details view 442 presents a graphic illustration of the reaction 440a.

Similarly, the screen shot 460 of FIG. 4C identifies that a pathway aconitate hydratase 436b described in the KEGG Enzyme data source 436b (e.g., the KEGG Enzyme Database maintained by Kanehisa Laboratories of Kyoto University Bioinformatics Center Kyoto) is associated with a reaction 440b of citrate=isocitrate. An Enzyme Commission (EC) number 462 of ec:4.2.1.3 provides a metabolic pathway identifier to locate the pathway data within the KEGG database. The EC number is a standard nomenclature for identifying enzymes. In another example, the EC number 462 may be cross-referenced with the Braunschweig Enzyme Database (BRENDA), maintained by the Technische Universitat Braunschweig of Brunswick, Del., to identify pathway data.

In each of the screen shots 430 and 460, in addition to a pathway/reaction tab 432 illustrating the various pathway information described above, a genes/drugs tab 434, upon selection, may present information regarding one or more target drugs. The genes/drugs information, for example, may be similar to the information provided in lower portion of the display 208 of FIG. 2.

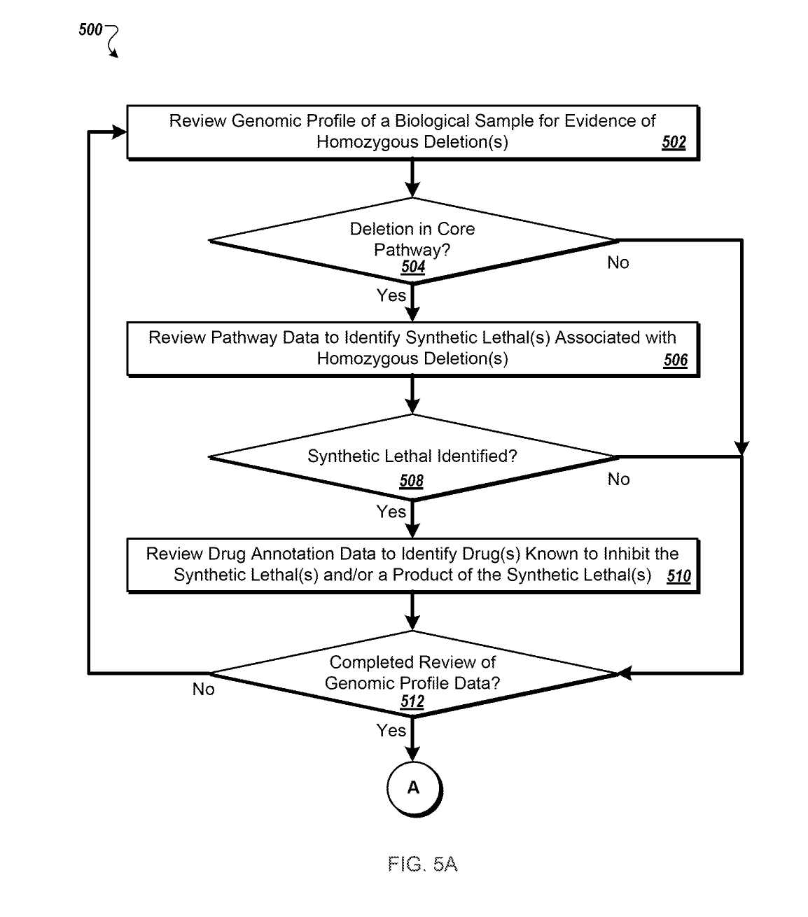

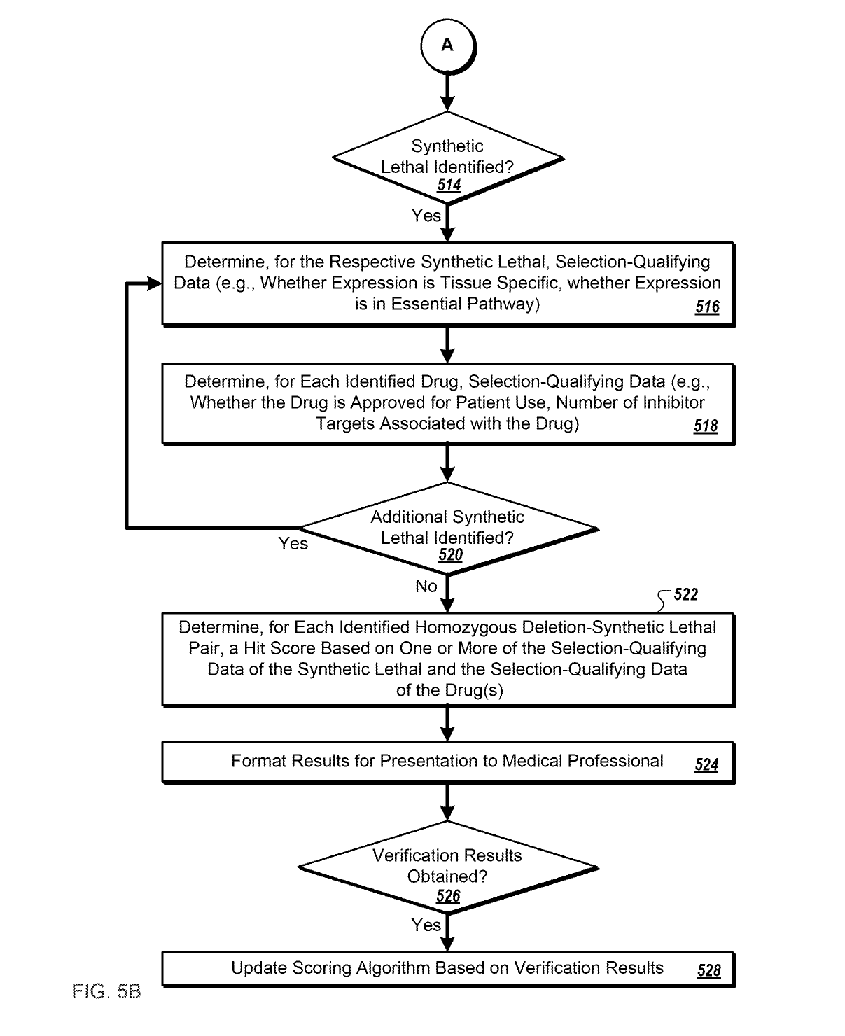

FIGS. 5A and 5B illustrate a flow chart of an example method 500 for identifying vulnerabilities in biological samples. The method 500, for example, may be performed by the vulnerability identification and analysis system 202 described in relation to FIG. 2 or the analysis system 102 described in relation to FIG. 1.

In some implementations, the method begins with reviewing a genomic profile of a biological sample of a subject for evidence of one or more homozygous deletions (502). The genomic profile, for example, may include data obtained through virtual karyotyping with SNP arrays, such as the Affymetrix Genome-Wide Human SNP 6.0 array by Affymetrix of Santa Clara, Calif. In other examples, the genomic profile data may include data obtained as biological sequencing output from a next generation medical sequencer or from other cytogenetic techniques such as fluorescent in situ hybridization, comparative genomic hybridization, or array comparative genomic hybridization. In some implementations, the genomic profile includes CNA (or CNV) data and/or gene expression profile data. The genomic profile data, in some implementations, is associated with a particular tissue type (e.g., the biological sample includes particular tissue sample). The genomic data may include aligned sequence data. The genomic profile data may be reviewed to identify one or more genes missing due to homozygous deletion. The identified homozygous deletions, in some implementations, are cross-referenced with copy number alteration (CNA) data and/or gene expression profile data to determine whether or not the suspected deletion is expressed by the sample. In this manner, the method 500 may attempt to confirm that a gene suspected of deletion has been deleted.

In some implementations, each identified homozygous deletion is reviewed to identify whether the deletion is in a core pathway (e.g., a pathway essential to the viability of the cell) (504). To identify vulnerabilities based upon homozygous deletion, for example, the method may screen to select only those homozygously deleted genes which are identified as performing functions core to the viability of a cell. If a tissue type of the biological sample is specified, those genes performing functions core to the viability of a cell of the particular tissue type may be identified. Additionally or alternatively, in some implementations, the homozygously deleted genes may be reviewed to reject those which are determined to be essential genes (e.g., essential to the viability of a particular organism). For example, by targeting a vulnerability in an essential function, the therapy may prove toxic to the subject. Core gene designation and/or essential gene designation, for example, may be derived through review of information accessed from the Database of Essential Genes (DEG) maintained by the Centre of BioInformatics of Tianjin University

In some implementations, the pathway data is reviewed to identify one or more synthetic lethal partners associated with each homozygous deletion (506). Synthetic lethal partners, for example, may perform a similar function or create a similar product to the gene which has been identified as being homozygously deleted. If the gene profile includes a tissue specific designation, in some implementations, the pathway data is reviewed to identify one or more synthetic lethal partners expressed within the particular tissue type. For example, should a synthetic lethal to the homozygous deletion fail to be expressed within a particular tissue type of the biological sample, targeting a therapeutic treatment to the unexpressed gene would likely fail to damage the cell. Likewise, if one of a plurality of partner genes is not typically expressed in the tissue type containing the homologous deletion (i.e., there are two or more synthetic lethal partner genes but only one of the partner genes is expressed in normal cells of the tissue type sought to be killed), then a target drug or drugs may be successfully lethal by inhibiting fewer than all of the known partner genes or gene products.

If one or more synthetic lethals as identified as being associated with one or more identified homozygous deletions (508), in some implementations, drug annotation data is reviewed to identify, for each identified synthetic lethal, one or more drugs known to inhibit the particular synthetic lethal (510). In some implementations, the drug annotation data includes identification of gene target information such as, in some examples, a number of targets (e.g., genes inhibited by the drug), and an identification of particular genes, metabolic reactions, gene expression products, and/or or pathway functions inhibited by the drug. This information may be reviewed to match target drugs to synthetic lethals. In this manner, the drug annotation data, may be reviewed to identify one or more drugs which can be used as a therapy to attack cells exhibiting a particular homozygous deletion by inhibiting any or all synthetic lethals of the particular homozygous deletion. Additionally, the drug annotation data, in some examples, may include identification of drug regulatory agency approval, approval for use in treatment of cancer, one or more active studies available for drugs pending approval, and/or a withdrawn (e.g., loss of regulatory agency approval) status. In some implementations, drug annotation data (e.g., drug regulatory agency approval, approval as a cancer therapy, a withdrawn status, one or more available studies related to the drug, one or more additional genes targeted by the drug, etc.) is collected for later reference. For example, the drug annotation data may be provided to a user in report data and/or used as selection factors in determining relative likelihood of success of two or more proposed homozygous deletion vulnerabilities to attack using a proposed drug therapy. In some implementations, the drug annotation data is collected from one or more external database systems, as described above in relation to FIG. 1. The drug annotation data, in some implementations, is converted to a standard format and stored within a local database system for reference.

In some implementations, steps 502 through 510 may be repeated for additional biological samples (e.g., when reviewing a cancer study or other collection of biological samples) (512).

If one or more homozygous deletions have been matched to one or more synthetic lethals associated with target drugs (514), in some implementations, for each synthetic lethal identified (520), selection-qualifying data associated with the synthetic lethal is identified (516). The selection qualifying data, in some examples, may include whether expression of the synthetic lethal is tissue specific, whether the synthetic lethal is an essential gene (e.g., essential to the viability of the organism), and/or whether expression of the synthetic lethal is in a core pathway (e.g., essential to the viability of the cell). In some implementations, the selection-qualifying data is collected upon identification of the synthetic lethals (e.g., as part of step 506). In some implementations, one or more additional databases are reviewed to supplement information derived at step 506. For example, synthetic lethals identified via review of pathway data may be cross-referenced with essential gene data.

In some implementations, selection-qualifying data associated with each target drug is identified (518). The selection-qualifying data, in some examples, may include a drug regulatory agency approval status, an approval status as a cancer therapy, a withdrawn status, one or more available studies related to the drug, and one or more additional genes targeted by the drug. The selection-qualifying data, in some implementations, is collected upon identification of the target drug (e.g., in step 510). In some implementations, one or more additional databases are reviewed to supplement information derived at step 510. For example, target drugs may be cross-referenced with a drug regulatory agency database to obtain up-to-date status information.

In some implementations, for each homozygous deletion-synthetic lethal pair, a hit score is calculated (522). The score may be intended to reflect a relative likelihood of success of tumor suppression based upon targeted drug therapy of the synthetic lethal(s) of the homozygous deletion. The hit score, for example, may be based on the selection-qualifying data of the synthetic lethal(s) and/or the selection-qualify data of the target drug(s). For example, the homozygous deletion—synthetic lethal combinations may be analyzed (e.g., scored and/or ranked) based upon a number of factors such as, in some examples, a number of drugs required (e.g., one drug targeted to one partner vs. two drugs, each targeted to one of two partners, etc.), whether each targeted drug has obtained approval for use in humans (e.g., drug regulatory agency approval, such as the United States Food and Drug Administration (FDA)), and a relative predicted lethality/toxicity of the proposed drug therapy (e.g., whether the function performed by the homozygous deletion is deemed a core function of the cell, whether the function performed by the homozygous deletion is deemed essential to the viability of one or more designated organisms, whether each targeted drug is believed to inhibit additional gene expression or function, etc.).

In some implementations, if not previously analyzed, each gene identified as being homozygously deleted may be evaluated to confirm its lack of expression (or under-expression) in cells of the biological sample. The level of expression may be rolled into the analysis, for example, to promote those therapies associated with a “confirmed” homozygous deletion.

In some implementations, results of identification and analysis are formatted for presentation (524). The results, for example, may be presented to a laboratory technician, referring doctor, pathologist, or other medical professional. Example report data is illustrated in the display 208 of FIG. 2 and the screen shots of FIGS. 4A through 4C.

In some implementations, one or more recommended drug therapies are verified (526). For example, biological samples may be exposed to selected drug therapies to identify whether the drug therapy succeeds in lethality to the targeted cells. In some implementations, verification is performed against one or more cell lines, such that a confidence factor of the results is increased. The verification, for example, may include one or more in vitro laboratory tests.

Based upon verification results, in some implementations, a scoring algorithm may be updated (528). For example, results may confirm or refute specific lethality to cancer cells of the biological sample(s). If verification was performed on multiple cell lines, for example, a confidence factor related to the recommended therapy may be promoted (or demoted) considerably, depending on the results. In another example if verification was performed on a single cell line, the verification results may be stored for later correlation to verification on a second cell line (e.g., to confirm or reject an initial assessment).

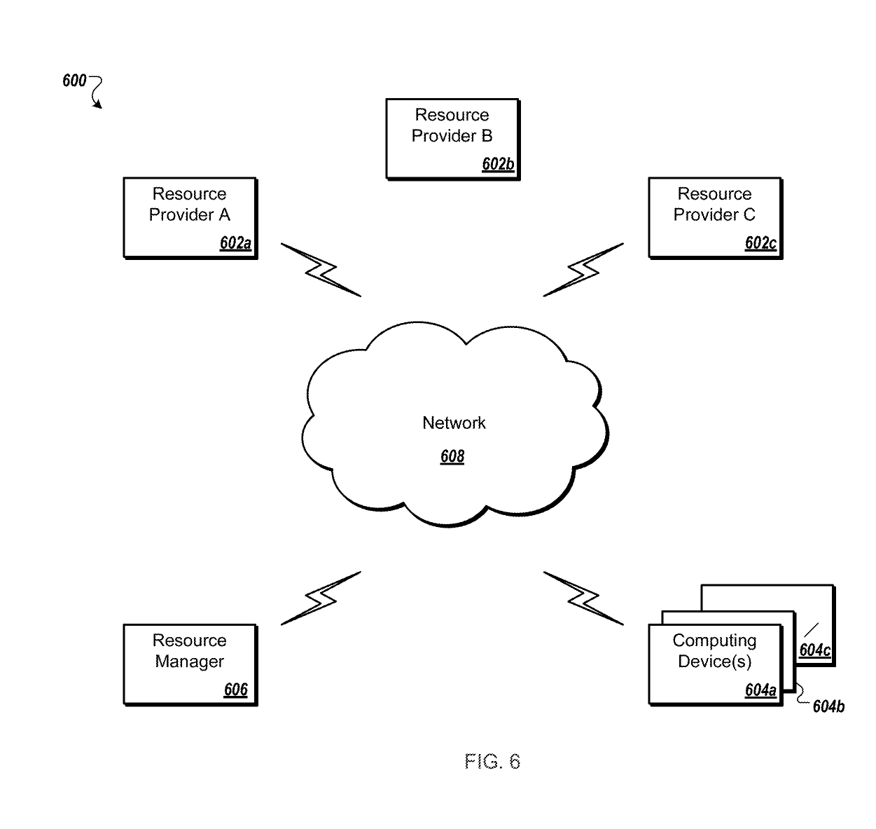

As shown in FIG. 6, an implementation of an exemplary cloud computing environment 600 for identifying metabolic vulnerabilities in biological samples is provided. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

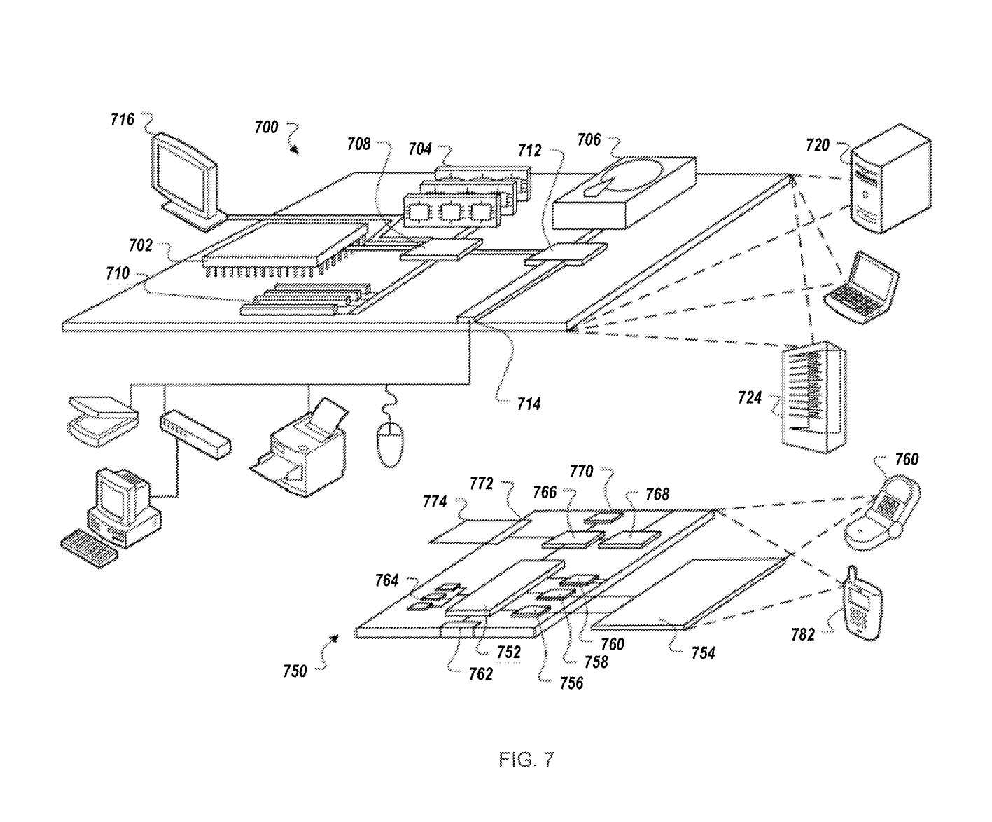

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, tablet computers, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### Example

### 1. Data Collection

1.1 Drug-Target Relationships

As a first step in the analysis, information on available targeted drugs and their known targets was collected. For this, drug-target data from multiple curated data resources including, but not limited, to DrugBank and KEGG Drug using the PiHelper tool (an open source framework for drug-target and antibody-target data) was gathered. Information from the National Cancer Institutes' Online Cancer Resource was also collected to annotate whether a drug has been approved for cancer therapy. Information for 7817 targeted drugs and 17981 drug-target relationships corresponding to these drugs was extracted. To remove non-specific drugs, drugs that have more than five known targets were excluded from the initial analysis, leaving a total of 7625 drugs and 15210 drug targets covering 1674 genes.

1.2 Gene Sets Representing Isoenzymes

A list of all known metabolic isoenzymes as representatives of synthetic lethal gene groups was next created. To accomplish this, curated human metabolic pathway information from Pathway Commons in BioPAX format was used. Metabolism pathways provided by Reactome and HumanCyc databases were specifically collected. Using these data resources, official gene symbols were extracted from protein entities that catalyze the same metabolic reaction, and these were considered as isoenzymes.

In addition to these pathway databases described above, metabolic enzyme information provided by the KEGG Enzyme database was also used. For each enzyme, identified by a specific Enzyme Commission (EC) number, the corresponding human gene symbols were extracted and grouped as isoenzyme gene sets.

Combining data from these three resources, 1290 unique gene sets were extracted. 1063 gene sets consisting of more than five genes were filtered, as a preliminary screen showed that gene sets with more than five genes do not increase the number of predicted vulnerabilities in a considerable manner, as well as those that consist of only non-targetable genes.

1.3 Cancer Studies and Genomic Profiles

Next, genomic profiles and minimally somatic copy-number alteration data were obtained from publicly available cancer studies. To obtain information on multiple studies, the web service of the cBioPortal for Cancer Genomics was utilized. Categorical copy-number alteration (CNA) information was used in order to identify whether a gene were homozygously deleted for a given sample. Whenever available, normalized gene-expression levels for a homozygously-deleted gene of interest were collected to determine whether the gene were underexpressed compared to the rest of the samples in the same cancer study. For this analysis, genomic profiles for a total of 5971 samples (4999 tumor samples and 972 cell lines) from 16 different cancer studies that had publicly available CNA data (see Table 1 below) were used. All but two studies included in the set also had the mRNA expression data available.

TABLE 1
Results of screenings of 5971 samples from 16 different cancer studies.

| | | Genomic profiles | | | |
|---|---|---|---|---|---|
| Cancer study | Source | Samples | CNA | Exp. | Tissue |
| Acute Myeloid Leukemia | TCGA (17) | 191 | + | + | Bone |
| | | | | | marrow |
| Adenoid Cystic Carcinoma | MSKCC (18) | 60 | + | − | — |
| Bladder Cancer | MSKCC (19) | 97 | + | + | Bladder |
| Breast Invasive Carcinoma | TCGA (20) | 913 | + | + | — |
| Cancer Cell Line Encyclopedia | Novartis/Broad | 972 | + | + | — |
| | (21) | | | | |
| Colon and Rectum Adenocarcinoma | TCGA (22) | 575 | + | + | Colon |
| Glioblastoma Multiforme | TCGA (23) | 497 | + | + | Brain |
| Head and Neck Squamous Cell | TCGA | 306 | + | + | — |
| Carcinoma | | | | | |
| Kidney Renal Clear Cell Carcinoma | TCGA (24) | 436 | + | + | — |
| Lung Adenocarcinoma | Broad (25) | 182 | + | − | Lung |
| Lung Adenocarcinoma | TCGA | 230 | + | + | Lung |
| Lung Squamous Cell Carcinoma | TCGA (26) | 197 | + | + | Lung |
| Ovarian Serous Cystadenocarcinoma | TCGA (27) | 569 | + | + | Ovary |
| Prostate Adenocarcinoma | MSKCC (28) | 194 | + | + | Prostate |
| Sarcoma | MSKCC/Broad | 207 | + | + | Soft |
| | (29) | | | | tissue |
| Uterine Corpus Endometrioid | TCGA (30) | 363 | + | + | Uterus |
| Carcinoma | | | | | |
| | Total | 5971 | | | |

1.4 Additional Gene Annotations

Most of the isoenzymes showed tissue-specific expression patterns where the expression of an isoenzyme was restricted to a single or multiple tissues. This context-specific background information was used in the present analysis and the tissue associated with a cancer study was analyzed, when trying to find vulnerabilities. It is also known that some genes are essential for the viability of a cell, therefore targeting such genes causes some level of toxicity to all cells in a nonselective manner, making these genes unpreferred targets for an ideal therapy.

Therefore, the genes were annotated to recognize tissue-specific expression patterns and also their essentiality. Using Tissue-specific Gene Expression and Regulation (TiGER) database, tissue-specific genes were first extracted. In addition, when possible, the cancer studies were annotated with a tissue in accordance with the TiGER terminology. This data allowed for querying for a given sample associated with a cancer study, whether a gene of interest is expected to be expressed. The data provided by Database of Essential Genes (DEG) was then used to annotate whether a gene of interest is essential for the organism. Using this data set, a human gene was marked as essential if its homologue in any of the well-known model organisms is known to be essential for the viability of that particular organism.

### 2. Identification of Vulnerabilities

2.1 Sample-Specific Vulnerabilities

Putting all this information together, each sample was then analyzed in the data set—in the context of the cancer study it is associated with—to identify potential metabolic vulnerabilities. To accomplish this, for a given cancer study, a tumor or cell-line sample and an isoenzyme gene set, cases were studied where: (i) one or more isoenzymes is lost due to homozygous deletion; (ii) and the other expressed isoenzymes can be selectively targeted by at least one drug. Once the vulnerabilities were found in this selective manner, all possible drugs, selective or not, were included in the final results.

2.2 Vulnerability Scores

To sort all predicted vulnerabilities based on their internal consistency and annotations, a score of over 4.0 was assigned to each sample-specific vulnerability. For this, it was first determined whether a given sample-specific vulnerability satisfied any of the following criteria: (i) the homozygously deleted gene is also under-expressed (or not expressed); (ii) there are any FDA-approved drugs in the suggested drug list; (iii) there any “cancer” drugs in the suggested drug list, where a cancer drug means a drug that is currently FDA-approved and being used in cancer treatment; (iv) the target of the suggested drug is not an essential gene in any of the model organisms.

2.3 Vulnerabilities in Tumor Samples and Matching Cell Lines

The analysis was performed on 5971 cancer samples covering 16 distinct cancer studies and a total of 4104 metabolic vulnerabilities in 1019 tumor samples and 482 cancer cell lines were identified. 146 out of 4104 (4%) vulnerabilities had a score of 3; 31% 2; 51% 1; and 14% 0. Overall, 263 distinct homozygous deletions were identified that cause a predicted vulnerability (as shown in Table 2 below); and it was found that 220 out of 263 homozygous deletions were present in tumor samples, and that 71% of these had at least one matching cell line. It was also found that 1833 (44%) of the vulnerabilities could potentially be targeted with at least one FDA-approved drug, but in a less selective manner. One such example of this less selective targeting is the potential use of methotrexate when either DHFR or DHFRL1 is deleted in the sample, although the drug targets both genes in this isoenzyme pair (as shown in Table 3 below). Furthermore, it was found that 1695 out of 4104 (41%) vulnerabilities were identified; intervention with drugs would involve targeting at least one essential enzyme. The present specification incorporates herein by reference in its entirety Aksoy, Billent Arman, “Prediction of individualized therapeutic vulnerabilities in cancer from genomic profiles,” Bioinformatics Advance Access, published Mar. 24, 2014, which discusses, inter alia, additional examples and associated analysis.

TABLE 2
20 most common candidate therapeutic vulnerabilities detected in
the analysis of the 5971 cancer samples from 16 different studies

| | | | Vulnerable | | | |
|---|---|---|---|---|---|---|
| | | | samples | | | |
| | Isoenzyme | Deleted | | Cell | | |
| # | set | gene | Tumors | lines | Metabolic reaction | Drugs |
| 1 | EXTL2, | EXTL3 | 173 | 47 | glucuronyl- | Uridine- |
| | EXTL3 | | | | galactosyl- | Diphosphate- |
| | | | | | proteoglycan | N- |
| | | | | | 4-alpha-N- | Acetylglucosamine |
| | | | | | acetylglucosaminyltransferase | |
| 2 | PAPSS1, | PAPSS2 | 97 | 17 | adenylyl-sulfate | Adenosine-5′- |
| | PAPSS2 | | | | kinase | Phosphosulfate |
| 3 | CPT1C, | CPT1B | 90 | 10 | carnitine O- | L-Carnitine |
| | CPT1B, | | | | palmitoyltransferase | |
| | CPT2, | | | | | |
| | CPT1A | | | | | |
| 4 | A2M, | BMP1 | 68 | 2 | HDL-mediated lipid | Becaplermin |
| | BMP1 | | | | transport | |
| 5 | GOT1, | GOT1L1 | 65 | 27 | aspartate degradation | Maleic acid, 4′- |
| | GOT2, | | | | II | Deoxy-4′- |
| | GOT1L1 | | | | | Acetylyamino- |
| | | | | | | Pyridoxal-5′- |
| | | | | | | Phosphate |
| 6 | GYG1, | GYG2 | 58 | 0 | glycogenin | UDP-D-galactose |
| | GYG2 | | | | glucosyltransferase | |
| 7 | ATP2C1, | ATP2C2 | 57 | 20 | calcium transport I | Desflurane/Halothane |
| | ATP2C2 | | | | | |
| 8 | ADA, | ADAT3 | 53 | 13 | adenine and | Pentostatin |
| | ADAT3 | | | | adenosine salvage III | |
| 9 | SAT1, | SAT2 | 48 | 44 | diamine N- | Diminazene |
| | SAT2 | | | | acetyltransferase | |
| 10 | FNTA, | PGGT1B | 47 | 15 | protein | Tipifarnib |
| | PGGT1B | | | | geranylgeranyltransferase | |
| | | | | | type I | |
| 11 | DHFR, | DHFR | 47 | 5 | dihydrofolate | 5-Chloryl-2,4,6- |
| | DHFRL1 | | | | reductase | Quinazolinetriamine |
| 12 | AKR1B10, | CYP2E1 | 42 | 33 | methylglyoxal | Tolrestat |
| | AKR1B1, | | | | degradation III | |
| | CYP2E1 | | | | | |
| 13 | TK1, TK2 | TK2 | 42 | 8 | thymidine kinase | Dithioerythritol |
| 14 | ACAT1, | ACAT2 | 39 | 23 | acetyl-CoA C- | Sulfasalazine |
| | ACAT2 | | | | acetyltransferase | |
| 15 | ENO1, | ENO1 | 37 | 18 | phosphopyruvate | 2-Phosphoglycolic |
| | ENO2, | | | | hydratase | Acid |
| | ENO3 | | | | | |
| 16 | ACAT1, | ACAT1 | 36 | 22 | acetyl-CoA C- | Pyripyropene A |
| | ACAT2 | | | | acetyltransferase | |
| 17 | MTHFD1, | MTHFD1L | 34 | 24 | formate- | LY374571/LY249543 |
| | MTHFD1L | | | | tetrahydrofolate | |
| | | | | | ligase | |
| 18 | ALDH2, | ALDH3A2 | 30 | 28 | putrescine | Daidzin |
| | ALDH3A2 | | | | degradation III | |
| 19 | TRYP1, | TYRP1 | 12 | 71 | ethanol degradation | Fomepizole |
| | CAT | | | | IV | |
| 20 | AMY1A/B/C, | AMY1A/B/C | 1 | 61 | alpha-amylase | Acarbose |
| | AMY2A, | | | | | |
| | AMY2B | | | | | |

TABLE 3
List of vulnerabilities that may potentially be exploited with a cancer drug -
a drug that is approved by the FDA for use in cancer therapy. In some cases, deletion
of either of partner genes can result in a therapeutic vulnerability.

| # | Isoenzyme set | Cases | Metabolic reaction | Drug(s) of interest |
|---|---|---|---|---|
| 1 | TOP2B*, TOP2A* | 70 | DNA topoisomerase (ATP- | Daunorubicin, |
| | | | hydrolysing) | Epirubicin, Doxorubicin, |
| | | | | Etoposide, Dexrazoxane |
| 2 | DHFR*, DHFRL1* | 68 | dihydrofolate reductase | Methotrexate, |
| | | | | Pemetrexed, Pralatrexate |
| 3 | IKBKE*, TBK1*, | 46 | IkappaB kinase | Arsenic trioxide |
| | IKBKB, CHUK* | | | |
| 4 | LIG1, LIG3, LIG4* | 43 | DNA ligase (ATP) | Bleomycin |
| 5 | P4HB*, MTTP* | 34 | Chylomicron-mediated lipid | Vandetanib, Nilotinib, |
| | | | transport | Imatinib, |
| | | | | Bosutinib, Dasatinib |
| 6 | RRM1*, RRM2* | 33 | Synthesis and | Clofarabine, |
| | | | interconversion of | Fludarabine, |
| | | | nucleotide di- and | Gemcitabine |
| | | | triphosphates | |
| 7 | CMPK1, CMPK2* | 20 | UMP/CMP kinase | Gemcitabine |
| 8 | GGPS1*, FDPS* | 7 | dimethylallyltranstransferase | Zoledronate |
| 9 | PTGS2, PTGS1* | 3 | taglandin-endoperoxide | Thalidomide, |
| | | | synthase | Lenalidomide |
| 10 | TXNRD1, | 5 | thioredoxin-disulfide | Arsenic trioxide |
| | TXNRD2*, | | reductase | |
| | TXNRD3 | | | |
| 11 | TOP1 TOP3A*, | 4 | Irinotecan | Topotecan |
| | TOP1MT, TOP3B | | | |

In view of the structure, functions and apparatus of the systems and methods described here, in some implementations, a system and method for identifying metabolic vulnerabilities in biological samples are provided. Having described certain implementations of methods and apparatus for supporting the identification of metabolic vulnerabilities in biological samples, it will now become apparent to one of skill in the art that other implementations incorporating the concepts of the disclosure may be used. Therefore, the disclosure should not be limited to certain implementations, but rather should be limited only by the spirit and scope of the following claims.

1. A method comprising:
accessing genomic profile data of a biological sample;
identifying, by a processor of a computing device, within the genomic profile data, one or more homozygous deletions;
identifying, by the processor, for each homozygous deletion of a subset of the one or more homozygous deletions, at least one respective vulnerability, wherein identifying the at least one respective vulnerability comprises identifying, for the respective homozygous deletion, one or more partner genes as synthetic lethal for a cell of the biological sample;
identifying, by the processor, for each gene of a subset of the one or more partner genes of at least a first homozygous deletion of the subset of homozygous deletions, at least one respective drug known to inhibit the gene and/or a product of the gene; and
providing, by the processor, for review by a medical professional, information regarding the at least one respective vulnerability and the at least one respective drug.

2. The method of claim 1, further comprising, prior to accessing the genomic profile data:
obtaining the biological sample; and
analyzing the biological sample, wherein analyzing the biological sample comprises performing at least one of a hybridization assay analysis and a gene sequencing analysis.

3. The method of claim 1,
wherein identifying the respective vulnerability comprises identifying a plurality of vulnerabilities, each of the plurality of vulnerabilities being associated with a respective homozygous deletion of the subset of homozygous deletions, and
wherein the method further comprises, prior to providing the information, analyzing the plurality of vulnerabilities in light of one or more factors to promote one or more vulnerabilities identified as being likely candidates for therapeutic success.

4. The method of claim 3, wherein analyzing the plurality of vulnerabilities comprises scoring each of the plurality of vulnerabilities based upon values associated with the one or more factors.

5. The method of claim 3, wherein the one or more factors comprise one or more drug selection factors including at least one of a) a drug regulatory agency approval status, b) a drug regulatory agency approval for cancer indication, and c) a number of additional targets modulated by the drug.

6. The method of claim 5, wherein identifying the respective drug comprises identifying the one or more drug selection factors.

7. The method of claim 3, wherein the one or more factors comprise one or more vulnerability selection factors including at least one of a) an essential gene designation of the homozygous deletion, b) a tissue specific designation of at least one partner gene of the one or more partner genes, and c) a core pathway function designation of the homozygous deletion.

8. The method of claim 7, wherein identifying the respective vulnerability comprises identifying the one or more vulnerability selection factors.

9. The method of claim 7, wherein:
the profile data comprises a tissue annotation designating a lineage of a tumor from which the biological sample was derived; and
analyzing the plurality of vulnerabilities in light of the one or more factors comprises analyzing whether the tissue specific designation of each respective partner gene identifies the respective partner gene as being expressed within a type of tissue designated by the tissue annotation.

10. The method of claim 3, wherein providing the information comprises providing values related to the one or more factors.

11. The method of claim 3, wherein the one or more factors comprise a gene expression level of the homozygous deletion within the biological sample.

12. The method of claim 11, wherein the respective gene expression level comprises one of under-expressed and not expressed.

13. The method of claim 3, wherein promoting one or more vulnerabilities comprises scoring the plurality of vulnerabilities according to the one or more factors.

14. The method of claim 13, wherein providing the information comprises providing, for each vulnerability of the plurality of vulnerabilities, a visual scale indicator, wherein the visual scale indicator identifies relative anticipated therapeutic success.

15. The method of claim 1, wherein identifying the one or more homozygous deletions comprises applying a predetermined threshold to separate homozygous deletions from non-homozygous deletions or amplifications.

16. The method of claim 1, wherein the respective vulnerability comprises a metabolic vulnerability.

17. The method of claim 1, wherein identifying the at least one respective vulnerability comprises reviewing at least one of metabolic pathway data, signaling pathway data, and cell-cell communication pathway data.

18. The method of claim 1, wherein identifying the respective vulnerability comprises identifying whether the homozygous deleted gene and/or partner gene performs an essential function to a designated organism.

19. The method of claim 18, wherein the designated organism comprises at least one of a yeast, a fly, a mouse, and a human.

20. The method of claim 1 comprising, prior to identifying the respective vulnerability, receiving selection of one or more pathway data sources.

21. The method of claim 20, wherein the pathway data sources comprise a type of biological pathway.

22. The method of claim 20, wherein the pathway data sources comprise one or more external databases.

23. The method of claim 1 comprising, prior to identifying the respective drug, receiving selection of one or more targeted drug data sources.

24. The method of claim 23, wherein the targeted drug data sources comprise an identification of at least one of drug regulatory agency approved drugs and cancer drugs.

25. The method of claim 1 comprising, after providing the information:
receiving verification results associated with a particular vulnerability of the at least one vulnerability and a particular drug; and
storing the verification results for use in identifying drugs to inhibit partner genes of homozygous deletions.

26. The method of claim 25, further comprising performing in vitro verification of the lethality of a particular drug to cells of the biological sample.

27. The method of claim 1, wherein:
accessing genomic profile data of the biological sample comprises accessing genomic profile data of a plurality of biological samples, and
identifying the at least one vulnerability comprises identifying, for each vulnerability of the at least one vulnerability, a number of samples exhibiting the respective vulnerability.

28. The method of claim 27, wherein the plurality of biological samples comprises biological tissue samples obtained via one or more cancer studies.

29. The method of claim 1, wherein the biological sample is a cancer sample.

30. The method of claim 29, wherein the cancer sample is from a patient having a carcinoma, sarcoma, myeloma, leukemia, or lymphoma.

31. A system comprising:
a processor; and
a memory having instructions stored thereon, wherein the instructions, when executed by the processor, cause the processor to:
access genomic profile data for each biological sample of a plurality of biological samples;
for each biological sample:
identify, within the respective genomic profile data, one or more homozygous deletions;
for at least a subset of biological samples of the plurality of biological samples:
identify, for each homozygous deletion of a subset of the one or more homozygous deletions, at least one respective vulnerability, wherein identifying the respective vulnerability comprises identifying, for the respective homozygous deletion, one or more partner genes as synthetic lethal for a cell of the biological sample, and
identify, for each gene of a subset of the one or more partner genes of at least a first homozygous deletion of the subset of homozygous deletions, at least one respective drug known to inhibit the gene and/or a product of the gene; and
provide, for review by a medical professional, result information regarding one or more vulnerabilities and corresponding drugs identified in relation to at least one prospective biological sample of the plurality of biological samples.

32. The system of claim 31, wherein:
the at least one prospective biological sample comprises a plurality of prospective biological samples; and
the instructions, when executed, cause the processor to identify, for the plurality of prospective biological samples, one or more groups of biological samples each associated with a same homozygous deletion.

33-45. (canceled)
